(19) United States
(12) Patent Application Publication
(10) Pub. No.: US 2026/0234395 A1
(43) Pub. Date: Aug. 13, 2026

(54) GRANULAR BODY, METHOD FOR PRODUCING SAME, AND THERMOPLASTIC RESIN COMPOSITION

(71) Applicant: KANEKA CORPORATION, Osaka-shi (JP)

(72) Inventor: Arisa SONOYAMA, Settsu-shi (JP)

(73) Assignee: KANEKA CORPORATION, Osaka-shi (JP)

(21) Appl. No.: 19/637,221

(22) Filed: Apr. 2, 2026

Related U.S. Application Data
(63) Continuation of application No. PCT/JP2024/035631, filed on Oct. 4, 2024.

(30) Foreign Application Priority Data
Oct. 4, 2023 (JP) 2023-172413
Oct. 4, 2023 (JP) 2023-172678

(51) Int. Cl. C08L 67/04; C08J 3/12; C08K 3/36; C08K 5/053

(52) U.S. Cl. CPC C08L 67/04; C08J 3/122; C08K 3/36; C08K 5/053; C08J 2367/04; C08J 2467/04; C08L 2201/06; C08L 2205/025

(57) ABSTRACT

A powdery and/or granular material having a median diameter of 20 μm to 10 mm includes crosslinked resin particles (A) and an aggregation inhibitor (B). The crosslinked resin particles (A) include a polyhydroxyalkanoate resin, and have a gel fraction of 50% or more and a volume mean diameter of 0.1 μm or more and 10 μm or less. The powdery and/or granular material can be produced by preparing an aqueous dispersion including the crosslinked resin particles (A) and the aggregation inhibitor (B) and spray drying the aqueous dispersion. By including the powdery and/or granular material and a thermoplastic resin (C), a thermoplastic resin composition can be formed.

### TECHNICAL FIELD

The present invention relates to a powdery and/or granular material including crosslinked resin particles, a method for producing the same, and a thermoplastic resin composition including the powdery and/or granular material.

### BACKGROUND ART

It is conventionally known that the introduction of a crosslinked structure into a resin can improve properties such as hardness, heat resistance, and solvent resistance of the resin. Small-diameter resin particles made of a resin having such a crosslinked structure are used in various applications such as a thermoplastic resin modifier, a spacer, an anti-blocking agent, and a delustering agent.

Known examples of a resin material constituting such crosslinked resin particles include an acrylic resin, an acrylic-silicone resin, and polystyrene (see Patent Literature 1 and 2, for example).

In the meanwhile, waste plastics have caused an adverse impact on the global environment, for example, by affecting ecosystems, emitting hazardous gases during combustion, or generating a huge amount of combustion heat which is partially responsible for global warming. As materials that can be a solution to this problem, biodegradable plastics are under active development.

Patent Literature 3 describes that a poly(3-hydroxyalkanoate), which is a biodegradable plastic, is melted and kneaded in the presence of an organic peroxide, whereby the resin is crosslinked. However, this literature describes that the crosslinked resin produced by melting and kneading in that manner is used to make a film or a sheet, and is quite silent about production of small-diameter crosslinked resin particles.

### CITATION LIST

### Patent Literature

Patent Literature 1: JP 2009-56770 A
Patent Literature 2: JP 2003-82191 A
Patent Literature 3: WO 2019/022008 A

### SUMMARY OF INVENTION

### Technical Problem

There are no known small-diameter crosslinked resin particles made of a biodegradable plastic and having biodegradability.

The present inventors have succeeded in producing crosslinked resin particles made of a polyhydroxyalkanoate resin, which is a resin with biodegradability, in an aqueous dispersion. The crosslinked resin particles are expected to be useful as crosslinked resin particles that address the problem of plastic waste and are environmentally friendly.

However, when trying to separate the crosslinked resin particles from the aqueous dispersion, the crosslinked resin particles are adhere and aggregated to each other along with evaporation of water to form a rubber-like sheet or a lump solid, and it has been difficult to separate the crosslinked resin particles in a form easy to handle.

In view of the above current situation, an object of the present invention is to provide crosslinked resin particles composed of a polyhydroxyalkanoate resin in a form having good handleability.

Another object of the present invention is to provide a thermoplastic resin composition capable of forming a molded article having improved impact resistance and/or tear strength.

### Solution to Problem

As a result of intensive studies, the present inventors have found that a powdery and/or granular material including crosslinked resin particles and having good handleability can be acquired by preparing an aqueous dispersion in which an aggregation inhibitor is dispersed together with crosslinked resin particles including a polyhydroxyalkanoate resin, and spray drying the aqueous dispersion, and the impact resistance and/or the tear strength of a thermoplastic resin can be improved by blending the powdery and/or granular material into the thermoplastic resin, and thus have accomplished the present invention.

That is, the present invention relates to a powdery and/or granular material having a median diameter of 20 μm to 10 mm, in which the powdery and/or granular material includes crosslinked resin particles (A) and an aggregation inhibitor (B), the crosslinked resin particles (A) include a polyhydroxyalkanoate resin, and have a gel fraction of 50% or more and a volume mean diameter of 0.1 μm or more and 10 μm or less.

The present invention also relates to a method for producing the powdery and/or granular material, the method including: a step of preparing an aqueous dispersion including crosslinked resin particles (A) and an aggregation inhibitor (B); and a step of spray drying the aqueous dispersion.

Additionally, the present invention also relates to a thermoplastic resin composition comprising the powdery and/or granular material and a thermoplastic resin (C).

### Advantageous Effects of Invention

According to the present invention, crosslinked resin particles including a polyhydroxyalkanoate resin can be provided in a form having good handleability.

According to a preferred aspect of the present invention, the aggregation inhibitor covers at least a part of the surface of the powdery and/or granular material, which is a secondary aggregate of the crosslinked resin particles, and the exposed surface of the crosslinked resin particles in the powdery and/or granular material is decreased, so that the adhesion or aggregation of the crosslinked resin particles is inhibited, and a powdery and/or granular material having high fluidity and good handleability can be acquired.

According to a preferred aspect of the present invention, even when the proportion of the crosslinked resin particles in the powdery and/or granular material is increased, it is possible to inhibit adhesion or aggregation between crosslinked resin particles.

In addition, by blending the powdery and/or granular material according to the present invention into a thermoplastic resin, the impact resistance and/or the tear strength of the thermoplastic resin can be improved. According to a preferred aspect of the present invention, impact resistance and/or tear strength can be enhanced without impairing the degree of freedom in compounding of a thermoplastic resin composition and the physical properties of the composition.

### BRIEF DESCRIPTION OF DRAWINGS

FIG. 1 is a micrograph (magnification: 1500) of a powdery and/or granular material obtained in Example 1.

FIG. 2 is a micrograph (magnification: 3500) of a powdery and/or granular material obtained in Example 2.

FIG. 3 is a micrograph (magnification: 8000) of a powdery and/or granular material obtained in Example 4.

FIG. 4 is a micrograph (magnification: 2000) of a powdery and/or granular material obtained in Example 9.

FIG. 5 is a micrograph (magnification: 3500) of a powdery and/or granular material obtained in Example 11.

FIG. 6 is a micrograph (magnification: 2200) of a powdery and/or granular material obtained in Example 12.

FIG. 7 is a micrograph (magnification: 2000) of a powdery and/or granular material obtained in Example 16.

### DESCRIPTION OF EMBODIMENTS

Hereinafter, an embodiment of the present invention will be described. The present invention is not limited to the embodiment described below.

The powdery and/or granular material according to the present embodiment includes at least crosslinked resin particles (A) and an aggregation inhibitor (B). The powdery and/or granular material is in a form having a particle diameter in a specific range, and thus has good handleability.

The crosslinked resin particles (A) will be described first.

### <Crosslinked Resin Particles (A)>

The crosslinked resin particles (A) are particles made using a polyhydroxyalkanoate resin as a main resin component. The polyhydroxyalkanoate resin may hereinafter be abbreviate as “PHA”.

### <PHA>

The “PHA” generically refers to a polymer containing a hydroxyalkanoic acid as a monomer unit and is generally biodegradable. The PHA is an aliphatic polyester and preferably a polyester containing no aromatic ring. The PHA preferably contains 50 mol % or more, more preferably 60 mol % or more, still more preferably 70 mol % or more of the hydroxyalkanoic acid repeating units in the total monomer repeating units (100 mol %). The upper limit of the proportion of the hydroxyalkanoic acid repeating units is not limited to a particular value, and the proportion is merely required to be 100 mol % or less.

Examples of the PHA include, but are not limited to, polyglycolic acid, a poly(3-hydroxyalkanoate) resin, and a poly(4-hydroxyalkanoate) resin. One PHA may be used alone or two or more PHAs may be used in combination. The PHA preferably includes a poly(3-hydroxyalkanoate) resin, and may be composed only of the poly(3-hydroxyalkanoate) resin. The poly(3-hydroxyalkanoate) resin may hereinafter be abbreviated as “P3HA”.

The P3HA is a polyhydroxyalkanoate containing 3-hydroxyalkanoic acid repeating units represented by [—CHR—CH₂—CO—O-] (in which R is an alkyl group represented by CₙH₂ₙ₊₁ and n is an integer from 1 to 15) as essential repeating units. The P3HA preferably contains 50 mol % or more, more preferably 60 mol % or more, still more preferably 70 mol % or more of the 3-hydroxyalkanoic acid repeating units in the total monomer repeating units (100 mol %). The upper limit of the proportion of the 3-hydroxyalkanoic acid repeating units is not limited to a particular value, and the proportion is merely required to be 100 mol % or less.

The P3HA is not limited to a particular type and may be a homopolymer containing the above repeating units or a copolymer containing the above repeating units. An example of the copolymer is a copolymer of 3-hydroxybutyric acid (hereinafter also referred to as “3HB”) and at least one monomer selected from the group consisting of 3-hydroxypropionic acid, 3-hydroxypentanoic acid, 3-hydroxyhexanoic acid, 3-hydroxyheptanoic acid, 3-hydroxyoctanoic acid, 3-hydroxynonanoic acid, 3-hydroxydecanoic acid, 3-hydroxyundecanoic acid, 3-hydroxydodecanoic acid, 3-hydroxytridecanoic acid, 3-hydroxytetradecanoic acid, 3-hydroxyhexadecanoic acid, and 3-hydroxyoctadecanoic acid. Another example of the copolymer is a copolymer of 3HB and at least one monomer selected from the group consisting of 4-hydroxybutyric acid, 4-hydroxypentanoic acid, 4-hydroxyhexanoic acid, 4-hydroxyheptanoic acid, 4-hydroxyoctanoic acid, 4-hydroxynonanoic acid, 4-hydroxydecanoic acid, 4-hydroxyundecanoic acid, 4-hydroxydodecanoic acid, 4-hydroxytridecanoic acid, 4-hydroxytetradecanoic acid, 4-hydroxyhexadecanoic acid, and 4-hydroxyoctadecanoic acid.

Specific examples of the copolymer include, but are not limited to, poly(3-hydroxybutyrate) abbreviated as P3HB, poly(3-hydroxybutyrate-co-3-hydroxyhexanoate) abbreviated as P3HB3HH, and poly(3-hydroxybutyrate-co-4-hydroxybutyrate) abbreviated as P3HB4HB.

One P3HA may be used alone or two or more P3HAs may be used in combination.

The term “poly(X-co-Y)” as used herein refers to a copolymer containing X repeating units and Y repeating units, namely, a copolymer resulting from copolymerization of a monomer from which the X repeating units are derived and a monomer from which the Y repeating units are derived.

During the P3HA production, a slight amount (about less than 1 mol %) of another monomer may be copolymerized. Insofar as the other monomer has no significant impact on the physical properties of the resulting P3HA, the other monomer is considered not to have been copolymerized and the P3HA is designated by a term which does not include the name of the other monomer.

The P3HA can be microbially produced. Such a microbially produced P3HA is typically a P3HA consisting only of D—(R-)hydroxyalkanoic acid repeating units. Among microbially produced P3HAs, P3HB, P3HB3HH, and P3HB4HB are preferred since they are easy to industrially produce. P3HB3HH and P3HB4HB are more preferred.

In the case where the P3HA contains 3-hydroxybutyric acid (3HB) repeating units, it is preferable, in terms of the balance of flexibility and strength, that the proportion of the 3HB repeating units be from 60 to 99 mol %, more preferably from 61 to 97 mol %, and even more preferably from 62 to 95 mol % in the total monomer repeating units (100 mol %). When the proportion of the 3HB repeating units is 60 mol % or more, the crosslinked resin particles (A) or the resin particles before the crosslinking treatment are easy to handle. When the proportion of the 3HB repeating units is 99 mol % or less, the flexibility of the crosslinked resin particles (A) tends to be easily secured. The monomer proportions in the P3HA can be measured by a method such as gas chromatography (see WO 2014/020838 A, for example). Two or more P3HAs differing in the proportion of the 3HB repeating units may be used in combination.

The microorganism for producing the P3HA is not limited to a particular type and may be any microorganism having a P3HA-producing ability. The first example of P3HB-producing bacteria is Bacillus megaterium discovered in 1925, and other known examples include naturally occurring microorganisms such as Cupriavidus necator (formerly classified as Alcaligenes eutrophus or Ralstonia eutropha) and Alcaligenes latus. These microorganisms accumulate P3HB in their cells.

Known examples of bacteria that produce copolymers of 3HB with other hydroxyalkanoates include Aeromonas caviae, which is a P3HB3HH-producing bacterium, and Alcaligenes eutrophus, which is a poly(3-hydroxybutyrate-co-4-hydroxybutyrate)-producing bacterium. In particular, in order to increase the P3HB3HH productivity, Alcaligenes eutrophus AC32 (FERM BP-6038) (T. Fukui, Y. Doi, J. Bacteriol., 179, pp. 4821-4830 (1997)) incorporating a P3HA synthase gene is preferred. Such a microorganism is cultured under suitable conditions to allow the microorganism to accumulate a P3HA in its cells, and the microbial cells accumulating the P3HA are used. Instead of the above microorganisms, a genetically modified microorganism incorporating any suitable P3HA synthesis-related gene may be used depending on the P3HA to be produced. The culture conditions including the type of the culture substrate may be optimized depending on the P3HA to be produced.

The molecular weight of the PHA is not limited to a particular range. The weight-average molecular weight of the PHA is preferably from 50,000 to 3,000,000, more preferably from 100,000 to 2,000,000, and even more preferably from 150,000 to 1,500,000. When the weight-average molecular weight is 50,000 or more, the crosslinked resin particles (A) can avoid the tendency to have low strength or the tendency to be sticky due to a low-molecular-weight component. On the other hand, when the weight-average molecular weight is 3,000,000 or less, production and handling of PHA can be facilitated. The above-mentioned values of the weight-average molecular weight are those measured before a crosslinking process of the PHA.

The weight-average molecular weight can be determined as a polystyrene-equivalent molecular weight measured by gel permeation chromatography (GPC, “High-performance liquid chromatograph 20A system” manufactured by Shimadzu Corporation) using polystyrene gels (such as “K-G 4A” and “K-806M” manufactured by Showa Denko K.K.) as columns and chloroform as a mobile phase. In this chromatography, calibration curves can be created using polystyrenes having weight-average molecular weights of 31,400, 197,000, 668,000, and 1,920,000. The columns used in the GPC may be any columns suitable for measurement of the molecular weight.

### <Gel Fraction>

The crosslinked resin particles (A) have a crosslinked structure formed by PHA molecular chains linked to each other. Since the amount of such a crosslinked structure is above a certain level, the crosslinked resin particles (A) have a high gel fraction, in particular a gel fraction of 50% or more. By virtue of such a high gel fraction, the hardness, heat resistance, solvent resistance, and the like of the resin particles including the PHA can be improved. By blending the crosslinked resin particles (A) into a thermoplastic resin, the mechanical strength such as impact strength and tear strength of the thermoplastic resin can be improved.

From the viewpoint of such improvement, the value of the gel fraction is preferably 60% or more, more preferably 70% or more, even more preferably 75% or more, and particularly preferably 80% or more. The gel fraction may be 85% or more, or 90% or more. The upper limit of the gel fraction is not limited to a particular value, and the gel fraction only needs to be 100% or less. In terms of the efficiency of production of the crosslinked resin particles (A), the gel fraction is preferably 99.5% or less and more preferably 99% or less. The gel fraction may be 98% or less, 97% or less, or 96% or less.

The gel fraction is measured as follows. The crosslinked resin particles (A) having been dried are added to chloroform to give a concentration of 0.7 wt % and dissolved at 60° C. for 30 minutes to afford a chloroform solution. Subsequently, the chloroform solution is allowed to stand at room temperature for 3 hours, after which the chloroform solution is filtered through a membrane filter having a pore diameter of 0.45 μm. The gel remaining on the filter is dried, and the total weight of the dried gel and the filter is measured. The gel fraction is calculated by the following equation.

Gel fraction (%)=[(weight of filter carrying dried gel−weight of filter alone)/weight of crosslinked resin particles used for measurement]×100

### <Volume Mean Diameter>

The crosslinked resin particles (A) have a volume mean diameter from 0.1 μm to 10 μm. When having such a diameter, a powdery and/or granular material having a particle diameter in a specific range according to the present embodiment can be formed, and the powdery and/or granular material can be used for various applications as described later. Furthermore, the mechanical strength such as impact strength and tear strength of a thermoplastic resin can also be improved. In terms of practical occasions for use, the lower limit value of the volume mean diameter is preferably 0.2 μm or more, more preferably 0.3 μm or more, and even more preferably 0.5 μm or more. In terms of productivity (such as the efficiency of production or crosslinking process of the PHA), the volume mean diameter is preferably up to 8 μm and more preferably up to 5 μm.

The volume mean diameter is a value measured for the crosslinked resin particles (A) dispersed in an aqueous solvent. The measurement device used can be a commonly-used measurement device, an example of which is Microtrac MT3300 EXII manufactured by Nikkiso Co., Ltd.

### <Peroxide>

The crosslinked resin particles (A) are not limited to a particular way of crosslinking, but are preferably resin particles crosslinked using a peroxide. When a peroxide is used, radicals generated by decomposition of the peroxide act on the molecules of the PHA to link the molecular chains of the PHA directly to each other, with the result that the crosslinked structure can be formed.

When the crosslinked resin particles (A) are resin particles crosslinked using a peroxide, the aqueous dispersion including the crosslinked resin particles (A) may contain a substance derived from the peroxide used (for example, decomposition products of the peroxide and the unreacted peroxide). Alternatively, a substance derived from the peroxide used may adhere to the surface or the like of the crosslinked resin particles (A) obtained. That is, when the crosslinked resin particles (A) are resin particles crosslinked using a peroxide, the crosslinked resin particles (A) or the powdery and/or granular material or thermoplastic resin composition according to the present embodiment may contain a substance derived from the peroxide. Therefore, when the crosslinked resin particles (A) or the powdery and/or granular material or thermoplastic resin composition according to the present embodiment is analyzed and a substance derived from a peroxide is detected, it is found that the crosslinked resin particles (A) are resin particles crosslinked using the peroxide.

The peroxide may be an organic peroxide or an inorganic peroxide. An organic peroxide is preferred because this can increase the gel fraction.

In view of factors such as the heating temperature and the time in the crosslinking process, the organic peroxide used is preferably at least one selected from the group consisting of a diacyl peroxide, an alkyl peroxyester, a dialkyl peroxide, a hydroperoxide, a peroxyketal, a peroxycarbonate, and a peroxydicarbonate.

Examples of the organic peroxide include butyl peroxyneododecanoate, octanoyl peroxide, dilauroyl peroxide, succinic peroxide, a mixture of toluoyl peroxide and benzoyl peroxide, benzoyl peroxide, bis(butylperoxy)trimethylcyclohexane, butyl peroxylaurate, dimethyldi (benzoylperoxy) hexane, bis(butylperoxy)methylcyclohexane, bis(butylperoxy)cyclohexane, butyl peroxybenzoate, butyl bis(butylperoxy) valerate, dicumyl peroxide, di-t-hexyl peroxide, t-butyl peroxy-2-ethylhexanoate, t-butyl peroxyisobutyrate, t-butyl peroxypivalate, t-hexyl peroxypivalate, t-butylperoxymethyl monocarbonate, t-pentylperoxymethyl monocarbonate, t-hexylperoxymethyl monocarbonate, t-heptylperoxymethyl monocarbonate, t-octylperoxymethyl monocarbonate, 1,1,3,3-tetramethylbutylperoxymethyl monocarbonate, t-butylperoxyethyl monocarbonate, t-pentylperoxyethyl monocarbonate, t-hexylperoxyethyl monocarbonate, t-heptylperoxyethyl monocarbonate, t-octylperoxyethyl monocarbonate, 1,1,3,3-tetramethylbutylperoxyethyl monocarbonate, t-butylperoxy-n-propyl monocarbonate, t-pentylperoxy-n-propyl monocarbonate, t-hexylperoxy-n-propyl monocarbonate, t-heptylperoxy-n-propyl monocarbonate, t-octylperoxy-n-propyl monocarbonate, 1,1,3,3-tetramethylbutylperoxy-n-propyl monocarbonate, t-butylperoxyisopropyl monocarbonate, t-pentylperoxyisopropyl monocarbonate, t-hexylperoxyisopropyl monocarbonate, t-heptylperoxyisopropyl monocarbonate, t-octylperoxyisopropyl monocarbonate, 1,1,3,3-tetramethylbutylperoxyisopropyl monocarbonate, t-butylperoxy-n-butyl monocarbonate, t-pentylperoxy-n-butyl monocarbonate, t-hexylperoxy-n-butyl monocarbonate, t-heptylperoxy-n-butyl monocarbonate, t-octylperoxy-n-butyl monocarbonate, 1,1,3,3-tetramethylbutylperoxy-n-butyl monocarbonate, t-butylperoxyisobutyl monocarbonate, t-pentylperoxyisobutyl monocarbonate, t-hexylperoxyisobutyl monocarbonate, t-heptylperoxyisobutyl monocarbonate, t-octylperoxyisobutyl monocarbonate, 1,1,3,3-tetramethylbutylperoxyisobutyl monocarbonate, t-butylperoxy-sec-butyl monocarbonate, t-pentylperoxy-sec-butyl monocarbonate, t-hexylperoxy-sec-butyl monocarbonate, t-heptylperoxy-sec-butyl monocarbonate, t-octylperoxy-sec-butyl monocarbonate, 1,1,3,3-tetramethylbutylperoxy-sec-butyl monocarbonate, t-butylperoxy-t-butyl monocarbonate, t-pentylperoxy-t-butyl monocarbonate, t-hexylperoxy-t-butyl monocarbonate, t-heptylperoxy-t-butyl monocarbonate, t-octylperoxy-t-butyl monocarbonate, 1,1,3,3-tetramethylbutylperoxy-t-butyl monocarbonate, t-butylperoxy-2-ethylhexyl monocarbonate, t-pentylperoxy-2-ethylhexyl monocarbonate, t-hexylperoxy-2-ethylhexyl monocarbonate, t-heptylperoxy-2-ethylhexyl monocarbonate, t-octylperoxy-2-ethylhexyl monocarbonate, 1,1,3,3-tetramethylbutylperoxy-2-ethylhexyl monocarbonate, diisobutyl peroxide, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, bis(4-t-butylcyclohexyl) peroxydicarbonate, bis(2-ethylhexyl) peroxydicarbonate, t-hexyl peroxyneodecanoate, t-butyl peroxyneodecanoate, t-butyl peroxyneoheptanoate, t-hexyl peroxypivalate, t-butyl peroxypivalate, di(3,5,5-trimethylhexanoyl) peroxide, dilauroyl peroxide, 1,1,3,3-tetramethylbutyl peroxy-2-ethylhexanoate, disuccinic acid peroxide, 2,5-dimethyl-2,5-bis(2-ethylhexanoylperoxy) hexane, t-hexyl peroxy-2-ethylhexanoate, di(4-methylbenzoyl) peroxide, dibenzoyl peroxide, t-butylperoxy-2-ethylhexyl carbonate, t-butylperoxyisopropyl carbonate, 1,6-bis(t-butylperoxycarbonyloxy) hexane, t-butyl peroxy-3,5,5-trimethylhexanoate, t-butyl peroxyacetate, t-butyl peroxybenzoate, t-amyl peroxy-3,5,5-trimethylhexanoate, 2,2-bis(4,4-di-t-butylperoxycyclohexyl) propane, and 2,2-di-t-butylperoxybutane. One organic peroxide may be used alone, or two or more organic peroxides may be used in combination.

Among the organic peroxides as listed above, t-butylperoxyisopropyl monocarbonate, t-pentylperoxyisopropyl monocarbonate, t-hexylperoxyisopropyl monocarbonate, t-butylperoxy-2-ethylhexyl monocarbonate, t-pentylperoxy-2-ethylhexyl monocarbonate, t-hexylperoxy-2-ethylhexyl monocarbonate, t-amylperoxyisopropyl monocarbonate, di-t-hexyl peroxide, t-butyl peroxy-2-ethylhexanoate, t-butyl peroxyisobutyrate, t-hexyl peroxy-2-ethylhexanoate, 1,1,3,3-tetramethylbutyl peroxy-2-ethylhexanoate, t-butyl peroxypivalate, t-hexyl peroxypivalate, t-butyl peroxyneodecanoate, t-hexyl peroxyneodecanoate, and 1,1,3,3-tetramethylbutyl peroxyneodecanoate are preferred since the use of these organic peroxides allows for efficient crosslinking of the PHA.

The peroxide is preferably a compound having a one-hour half-life temperature of 200° C. or lower because the heating temperature can be set low in the crosslinking process. The one-hour half-life temperature is more preferably 170° C. or lower and even more preferably 140° C. or lower. The one-hour half-life temperature may be at least 50° C., at least 60° C., or at least 70° C.

Particularly preferred examples of the organic peroxide having such a one-hour half-life temperature include t-butylperoxyisopropyl monocarbonate, t-butylperoxy-2-ethylhexyl monocarbonate, di-sec-butyl peroxydicarbonate, t-butyl peroxy-2-ethylhexanoate, t-butyl peroxyisobutyrate, t-hexyl peroxy-2-ethylhexanoate, 1,1,3,3-tetramethylbutyl peroxy-2-ethylhexanoate, t-butyl peroxypivalate, t-hexyl peroxypivalate, t-butyl peroxyneodecanoate, t-hexyl peroxyneodecanoate, and 1,1,3,3-tetramethylbutyl peroxyneodecanoate.

When the peroxide is an inorganic peroxide, examples of the inorganic peroxide include hydrogen peroxide, potassium peroxide, calcium peroxide, sodium peroxide, magnesium peroxide, potassium persulfate, sodium persulfate, and ammonium persulfate, which are preferred in view of the heating temperature and the time in the crosslinking process. Among these peroxides, hydrogen peroxide, potassium persulfate, sodium persulfate, and ammonium persulfate are preferred because they are easy to handle and have a decomposition temperature suitable for the heating temperature in the crosslinking process. One inorganic peroxide may be used alone, or two or more inorganic peroxides may be used in combination. Alternatively, an organic peroxide and an inorganic peroxide may be used in combination.

### <Polyfunctional Compound>

The crosslinked structure of the crosslinked resin particles (A) may be introduced using only a peroxide or using both a peroxide and a polyfunctional compound. With the use of both a peroxide and a polyfunctional compound, the gel fraction of the crosslinked resin particles (A) can be increased with a reduced amount of the peroxide.

The polyfunctional compound refers to a compound having in the molecule two or more functional groups able to crosslink the PHA. The polyfunctional compound is not limited to a particular type but preferably a compound reactive with radicals generated from the peroxide and particularly preferably a compound having two or more radical-reactive groups in the molecule. The radical-reactive groups preferably include at least one functional group selected from the group consisting of vinyl, allyl, acryloyl, and methacryloyl groups.

Examples of the polyfunctional compound include, but are not limited to: allyl (meth)acrylate; allyl alkyl (meth)acrylates; allyloxy alkyl (meth)acrylates; polyfunctional (meth)acrylates having two or more (meth)acrylic groups, such as ethylene glycol di(meth)acrylate, butanediol di(meth)acrylate, triethylene glycol di(meth)acrylate, tetraethylene glycol di(meth)acrylate, polyethylene glycol di(meth)acrylate, trimethylolpropane tri(meth)acrylate, and pentaerythritol (meth)acrylate; divinylbenzene; diallyl phthalate; triallyl cyanurate; triallyl isocyanurate; and divinylbenzene. Preferred are allyl methacrylate, triallyl isocyanurate, butanediol di(meth)acrylate, and divinylbenzene. Particularly preferred are allyl methacrylate and triallyl isocyanurate.

When the crosslinked structure is formed in the presence of a polyfunctional compound, the resulting crosslinked resin particles (A) can usually contain a structure derived from the polyfunctional compound. In this case, the molecular chains of the PHA are linked to each other via the structure derived from the polyfunctional compound.

The crosslinked resin particles (A) may consist only of the PHA having a crosslinked structure or may further contain components other than the PHA having a crosslinked structure. Examples of the components other than the PHA having a crosslinked structure include a resin other than the PHA, an antioxidant, a hydrolysis inhibitor, an anti-blocking agent, a nucleating agent, and an ultraviolet absorber.

The proportion of the PHA or the P3HA in the crosslinked resin particles (A) is not limited to a particular range and may be 50 wt % or more. The proportion of the PHA or the P3HA is preferably 70 wt % or more, more preferably 80 wt % or more, still even more preferably 90 wt % or more, and particularly preferably 95 wt % or more. The proportion of the PHA may be 99 wt % or more. The upper limit of the proportion of the PHA is not limited to a particular value and may be any value of 100 wt % or less.

Examples of the resin other than the PHA include aliphatic polyesters other than the PHA and aliphatic-aromatic polyesters. Examples of the aliphatic polyester other than the PHA include: (i) polycaprolactone (PCL); (ii) polylactic acid (PLA); and (iii) an aliphatic polyester having a structure resulting from polycondensation of an aliphatic diol and an aliphatic dicarboxylic acid. Examples of the aliphatic polyester having a structure resulting from polycondensation of an aliphatic diol and an aliphatic dicarboxylic acid include polyethylene succinate, polybutylene succinate (hereinafter sometimes referred to as “PBS”), polyhexamethylene succinate, polyethylene adipate, polybutylene adipate, polyhexamethylene adipate, polybutylene succinate adipate (hereinafter sometimes referred to as “PBSA”), polyethylene sebacate, and polybutylene sebacate. Examples of the aliphatic-aromatic polyester include an aliphatic-aromatic polyester obtained by using both an aliphatic compound and an aromatic compound as monomers and copolymerizing these monomers. Examples of the aliphatic-aromatic polyester include polybutylene adipate terephthalate (hereinafter sometimes referred to as “PBAT”), polybutylene sebacate terephthalate, polybutylene azelate terephthalate, polybutylene succinate terephthalate (hereinafter sometimes referred to as “PBST”), and polybutylene succinate adipate terephthalate. One of the resins other than the PHA may be used alone, or two or more thereof may be used in combination. In the crosslinked resin particles (A), a resin other than the PHA may be crosslinked or may not be crosslinked.

The crosslinked resin particles (A) are preferably unfoamed particles unlike foamed resin particles as disclosed in WO 2007/049694 A or WO 2019/146555 A. That is, the crosslinked resin particles (A) are preferably substantially free of internal bubbles.

When the crosslinked resin particles (A) are unfoamed particles, the crosslinked resin particles (A) have a relatively high apparent density. The apparent density is preferably more than 0.6 g/cm³, more preferably 0.7 g/cm³ or more, and even more preferably 0.9 g/cm³ or more. The apparent density of the crosslinked resin particles (A) can be determined by a method as described in JIS K 0061 (Test methods for density and relative density of chemical products) or a method as described in JIS Z 8807 (Methods of measuring density and specific gravity of solid).

The average weight per particle of the crosslinked resin particles (A) is not limited to a particular range. Since the crosslinked resin particles (A) are small-diameter particles having a volume mean diameter of 10 μm or less, the average weight per particle is much smaller than 0.1 mg.

### <Method for Producing Crosslinked Resin Particles (A)>

One example of a method for producing the crosslinked resin particles (A) will be described in detail. The crosslinked resin particles (A) can be produced by crosslinking a PHA in the presence of a peroxide in an aqueous dispersion containing uncrosslinked PHA-containing resin particles (hereinafter sometimes referred to as uncrosslinked resin particles). To efficiently crosslink the PHA, it is preferable to heat the aqueous dispersion of the uncrosslinked resin particles containing the peroxide to a temperature suitable for decomposition of the peroxide.

More specifically, the method for producing the crosslinked resin particles (A) preferably includes a step (1) of preparing an aqueous uncrosslinked resin particle dispersion containing uncrosslinked resin particles dispersed in water; a step (2) of adding a peroxide to the aqueous uncrosslinked resin particle dispersion to impregnate the uncrosslinked resin particles with the peroxide; and a step (3) of heating the aqueous dispersion of the peroxide-impregnated uncrosslinked resin particles to a heating temperature to crosslink the PHA. More preferably, the method further includes the step (4) of maintaining the heating temperature after adding all of the peroxide.

In the step (1), the aqueous dispersion of the uncrosslinked resin particles may be an aqueous dispersion obtained by culturing a PHA-producing microorganism to accumulate PHA particles in the microbial cells, then disrupting the microbial cells in the culture fluid, and separating and removing the cellular components. The aqueous dispersion thus obtained may be concentrated or diluted, and the concentrated or diluted dispersion may be used as the aqueous dispersion of the uncrosslinked resin particles. When the aqueous dispersion of the uncrosslinked resin particles is obtained in the above way, the procedures from the PHA particle preparation by culture of the PHA-producing microorganism to the crosslinking process can be carried out without separating the PHA particles (namely, the uncrosslinked resin particles) from water.

Alternatively, the aqueous dispersion of the uncrosslinked resin particles can be prepared by dispersing dried uncrosslinked resin particles in water. The aqueous dispersion may contain, in addition to water, a water-miscible organic solvent as mentioned later.

In the aqueous dispersion, the volume mean diameter of the uncrosslinked resin particles is preferably in the same range as the volume mean diameter of the crosslinked resin particles (A) described above. When the PHA particles are those produced by a PHA-producing microorganism, the volume mean diameter of the PHA particles can be usually in the above-specified range; thus, an aqueous dispersion of uncrosslinked resin particles having a desired volume mean diameter can be obtained without the need for any special step for particle diameter adjustment.

The concentration of the uncrosslinked resin particles in the aqueous dispersion is not limited to a particular range and can be set as appropriate. The concentration of the uncrosslinked resin particles may be, for example, from about 1 to about 70 wt % and is preferably from about 5 to about 50 wt %.

The aqueous dispersion of the uncrosslinked resin particles preferably contains a dispersant to enhance the dispersibility of the uncrosslinked resin particles and allow the crosslinking reaction to take place uniformly. Examples of the dispersant include: anionic surfactants such as sodium dioctyl sulfosuccinate, sodium dodecyl sulfate, sodium lauryl sulfate, and sodium oleate; cationic surfactants such as lauryltrimethylammonium chloride; non-ionic surfactants such as glycerin fatty acid esters, sorbitan fatty acid esters, sucrose fatty acid esters, polyoxyethylene alkyl ethers, polyoxyethylene alkyl phenyl ethers, and polyoxyethylene polyoxypropylene glycol; and water-soluble polymers such as polyvinyl alcohol, ethylene-modified polyvinyl alcohol, polyvinylpyrrolidone, methylcellulose, ethylcellulose, hydroxymethylcellulose, hydroxyethylcellulose, polyacrylic acid, sodium polyacrylate, potassium polyacrylate, polymethacrylic acid, and sodium polymethacrylate. One of these dispersants may be used alone, or two or more thereof may be used in combination.

When a dispersant is used, the amount of the dispersant added is not limited to a particular range and may be, for example, from 0.1 to 10 parts by weight per 100 parts by weight of the uncrosslinked resin particles. The amount of the dispersant is preferably from 0.5 to 5 parts by weight, and particularly preferably from 0.5 to 3 parts by weight per 100 parts by weight of the uncrosslinked resin particles.

In the step (2), a peroxide is added to the aqueous dispersion of the uncrosslinked resin particles obtained in the step (1) to impregnate the uncrosslinked resin particles with the peroxide. The peroxide used can be any of those mentioned above. The peroxide added may be in any form such as a solid or liquid. The peroxide added may be a liquid diluted with a diluent or the like. The peroxide may be added all at once, or may be added continuously or in batches.

When the peroxide and the polyfunctional compound as described above are used in combination, the polyfunctional compound is preferably added to the aqueous dispersion of the uncrosslinked resin particles in the step (2). The polyfunctional compound used can be any of those mentioned above. The polyfunctional compound added may be in any form such as a solid or liquid. The peroxide added may be a liquid diluted with a diluent or the like. The polyfunctional compound may be added all at once, or may be added continuously or in batches.

The impregnation of the uncrosslinked resin particles with the peroxide and the optionally-used polyfunctional compound may be accomplished as follows: after or concurrently with the addition of these compounds to the aqueous dispersion of the uncrosslinked resin particles, the temperature of the aqueous dispersion is set, for example, to a temperature that is 0° C. or higher but is lower than the temperature employed in the next step (3) as a temperature suitable for decomposition of the peroxide, and such a temperature of the aqueous dispersion is maintained, for example, for about 1 minute to about 5 hours with stirring of the aqueous dispersion. Specifically, the temperature of the aqueous dispersion during the impregnation may be from about 10 to about 60° C.

The amount of the peroxide used can be set as appropriate in view of the gel fraction of the crosslinked resin particles (A). For example, the amount of the peroxide is preferably from 0.01 to 10 parts by weight, more preferably from 0.1 to 8 parts by weight, even more preferably from 0.3 to 5 parts by weight, and particularly preferably from 0.5 to 3 parts by weight per 100 parts by weight of the uncrosslinked resin particles.

With the production method in which uncrosslinked resin particles are crosslinked using a peroxide in an aqueous dispersion of the uncrosslinked resin particles, it is easy to obtain crosslinked resin particles by allowing the crosslinking to proceed while keeping the particle diameter (volume) the same as before the crosslinking. This could be difficult to achieve by a method in which a resin is crosslinked by melting and kneading it in the presence of a peroxide.

The production method in which uncrosslinked resin particles are crosslinked using a peroxide in an aqueous dispersion of the uncrosslinked resin particles is also advantageous in that the temperature increase due to heat generated during the crosslinking reaction can be easily controlled and that crosslinked resin particles having a stable crosslinked structure (quality) can be obtained safely and efficiently.

The amount of the polyfunctional compound used may also be set as appropriate in view of the gel fraction of the crosslinked resin particles (A). For example, the amount of the polyfunctional compound is preferably from 0.01 to 20 parts by weight, more preferably from 0.05 to 15 parts by weight, even more preferably from 0.1 to 10 parts by weight, still even more preferably from 0.2 to 5 parts by weight, and particularly preferably from 0.3 to 3 parts by weight per 100 parts by weight of the uncrosslinked resin particles.

In the step (3), the aqueous dispersion of the peroxide-impregnated uncrosslinked resin particles is heated to a temperature suitable for decomposition of the peroxide. The heating temperature preferably ranges from a temperature about 25° C. below the above-described one-hour half-life temperature of the peroxide to a temperature about 25° C. above the one-hour half-life temperature of the peroxide. To be specific, the heating temperature is preferably from 30 to 140° C., more preferably from 50 to 135° C., and even more preferably from 60 to 130° C. With this method, the PHA can be crosslinked at a temperature lower than the melting temperature of the PHA and thus can avoid its deterioration caused by heating in the crosslinking process.

In the subsequent step (4), it is preferable to maintain the above heating temperature. This allows for satisfactory completion of the peroxide-mediated crosslinking reaction. The time for which the heating temperature is maintained is not limited to a particular range but preferably from 1 minute to 15 hours and more preferably from 1 to 10 hours.

By performing the above steps (1) to (4), an aqueous dispersion of the crosslinked resin particles (A) can be obtained. The powdery and/or granular material according to the present embodiment can be produced using this aqueous dispersion. Details will be described later.

### <Aggregation Inhibitor (B)>

The powdery and/or granular material according to the present embodiment includes an aggregation inhibitor (B) in addition to the crosslinked resin particles (A). When including the aggregation inhibitor (B), it is possible to form a powdery and/or granular material having good handleability despite including the crosslinked resin particles (A).

The aggregation inhibitor (B) is a component capable of reducing or preventing adhesion or aggregation of the crosslinked resin particles (A) when the crosslinked resin particles (A) are dried. When the aggregation inhibitor (B) is present to cover at least a part of the surface of the powdery and/or granular material which is a secondary aggregate of the crosslinked resin particles (A), the exposed surface of the crosslinked resin particles (A) in the powdery and/or granular material decreases, whereby the adhesion or aggregation of the crosslinked resin particles (A) can be inhibited. More specifically, it is possible to reduce or prevent secondary aggregation of a dried product of the crosslinked resin particles (A) (for example, a powdery and/or granular material obtained by drying the crosslinked resin particles (A) by a spray drying method) and adhesion of the crosslinked resin particles (A) to facilities, machines, containers, and the like to be used during drying and melt-kneading. As a result, it is possible to acquire a powdery and/or granular material having high fluidity and good handleability. In addition, there is also an advantage that the productivity can be improved and the ranges of conditions and methods of melt-kneading can be expanded.

From the viewpoint of further inhibiting adhesion or aggregation of the crosslinked resin particles (A), the surface coverage of the crosslinked resin particles (A) with the aggregation inhibitor (B) is preferably 10% or more. The surface coverage is more preferably 20% or more, still more preferably 30% or more, and particularly preferably 50% or more. The upper limit of the surface coverage is not limited to a particular value, and the surface coverage only needs to be 100% or less.

The surface coverage is a value determined as follows. In an electron micrograph taken by photographing the appearance of a powdery and/or granular material, the area is calculated for each of a region where the surface of a secondary aggregate of the crosslinked resin particles (A) is covered with the aggregation inhibitor (B) and a region where the surface of the secondary aggregate of the crosslinked resin particles (A) is exposed without being covered with the aggregation inhibitor (B), and the surface coverage is calculated from the areas on the basis of the following formula.

Surface coverage (%)=[area of region where surface of secondary aggregate of crosslinked resin particles (A) is covered with aggregation inhibitor (B)/(area of region where surface of secondary aggregate of crosslinked resin particles (A) is covered with aggregation inhibitor (B)+area of region where surface of secondary aggregate of crosslinked resin particles (A) is exposed)]×100

The aggregation inhibitor (B) may be either an inorganic component or an organic compound. Each of the inorganic component and the organic compound may be used, or both may be used in combination. In addition, two or more inorganic components may be used in combination, or two or more organic compounds may be used in combination.

As the inorganic component that can be used as the aggregation inhibitor (B), a component known as an inorganic filler for a thermoplastic resin can be used. Examples thereof include silica-based inorganic fillers such as quartz, fumed silica, silicic anhydride, molten silica, crystalline silica, amorphous silica, a filler obtained by condensation of alkoxysilane, and ultrafine amorphous silica, alumina, zircon, iron oxide, zinc oxide, titanium oxide, silicon nitride, boron nitride, aluminum nitride, silicon carbide, glass, silicone rubber, silicone resin, titanium oxide, carbon fiber, mica, black lead, carbon black, ferrite, graphite, diatomite, white clay, clay, talc, calcium carbonate, manganese carbonate, magnesium carbonate, barium sulfate, and silver powder. These may be surface-treated in order to improve dispersibility in the resin composition. These organic components may be used alone, or two or more organic components may be used in combination.

The organic compound that can be used as the aggregation inhibitor (B) is not particularly limited, but is preferably a water-soluble compound from the viewpoint of ease of handling during spray drying.

Examples of such an organic compound include, but are not particularly limited to, polyhydric alcohols, fatty acid amides, polysaccharides, oligosaccharides, and glycerin fatty acid esters. These organic components may be used alone, or two or more organic components may be used in combination.

Examples of the polyhydric alcohol include ethylene glycol, propylene glycol, diethylene glycol, glycerin, trimethylolpropane, trimethylolethane, 1,2,6-hexanetriol, erythritol, pentaerythritol, threitol, arabinitol, xylitol, ribitol, iditol, galactitol, glucitol, mannitol, sorbitol, inositol, maltitol, and lactitol. Among them, sugar alcohols are preferable, and pentaerythritol is particularly preferable.

Examples of the fatty acid amide include behenamide, erucamide, lauramide, coconut acid amide, stearamide, palmitamide, behenamide, brassidamide, acetamide, benzamide, propionamide, oleamide, and ricinoleamide. Among them, behenamide and/or erucamide are preferable.

Examples of the polysaccharide include chitin, chitosan, starch, cellulose, agarose, carrageenan, heparin, hyaluronic acid, alginic acid, pectin, xyloglucan, glucomannan, glycogen, dextran, cellulose, and cellulose derivatives such as acetyl cellulose and methyl cellulose.

Examples of the oligosaccharide include fructooligosaccharides, soybean oligosaccharides, galactooligosaccharides, xylooligosaccharides, isomaltooligosaccharides, lactosucrose, and cyclic oligosaccharides such as cyclodextrin and cycloisomaltooligosaccharides.

Examples of the glycerin fatty acid ester include monoglycerides, acetylated monoglycerides, organic acid monoglycerides, and polyglycerin fatty acid esters.

Incidentally, among the compounds described above as the aggregation inhibitor (B), there are compounds that can exhibit an effect other than aggregation inhibition (for example, nucleating agents, inorganic fillers, organic fillers, inorganic fillers, antioxidants, hydrolysis inhibitors, ultraviolet absorbers, colorants such as dyes and pigments, and antistatic agents).

<Powdery and/or Granular Material>

The powdery and/or granular material according to the present embodiment includes the crosslinked resin particles (A) and the aggregation inhibitor (B) as described above.

In the present description, the “powdery and/or granular material” encompasses both a powdery material and a granular material. In the present description, the “powdery and/or granular material” is intended to refer to an object having a median diameter of 20 μm to 10 mm. The shape of the powdery and/or granular material is not limited to a particular shape, and may be, for example, a substantially spherical shape, a flat shape, a cubic shape, a spindle shape, or a needle shape. The powdery and/or granular material is preferably in a powdery form and/or a granular form, but may be in the form of pellets as long as the median diameter falls within the range described above.

In the powdery and/or granular material, the proportion of the crosslinked resin particles (A) in the total amount of the crosslinked resin particles (A) and the aggregation inhibitor (B) is preferably 10 wt % or more, more preferably 20 wt % or more, and still more preferably 30 wt % or more because in such a case, for example, the effect of improving the mechanical strength, such as impact resistance or tear strength, of a thermoplastic resin by the crosslinked resin particles (A) is easily achieved. The proportion of the crosslinked resin particles (A) may be 40 wt % or more. The upper limit of the proportion of the crosslinked resin particles (A) is preferably 99.5 wt % or less, more preferably 99 wt % or less, and still more preferably 98 wt % or less because the handleability of the powdery and/or granular material can be further improved. The upper limit may be 95 wt % or less, or 90 wt % or less.

The powdery and/or granular material according to the present embodiment may be constituted of substantially only the crosslinked resin particles (A) and the aggregation inhibitor (B), but one or more of a dispersant or an emulsifier, a pH adjuster, an inorganic filler, a colorant such as a pigment or a dye, an odor absorber such as activated carbon or zeolite, a fragrance such as vanillin or dextrin, a plasticizer, an antioxidant, an anti-oxidizing agent, a weather resistance improver, an ultraviolet absorber, a nucleating agent, a lubricant, a mold release agent, a water repellent, an antibacterial agent, a slidability improver, and the like may be contained as long as the effect of the invention is not impaired.

The powdery and/or granular material according to the present embodiment may contain various components resulting from the process of the production method as long as the effects of the invention are not impaired.

In the powdery and/or granular material according to the present embodiment, the crosslinked resin particles (A) and the aggregation inhibitor (B) are main components. Specifically, the total proportion of the crosslinked resin particles (A) and the aggregation inhibitor (B) in the entire powdery and/or granular material may be usually from 60 to 100 wt %, from 80 to 100 wt %, from 90 to 100 wt %, from 95 to 100 wt %, or from 99 to 100 wt %. The upper limit may be 99.9 wt % or less, or 99 wt % or less.

The median diameter of the powdery and/or granular material according to the present embodiment is 20 μm to 10 mm, preferably 25 μm to 7 mm, more preferably 30 μm to 5 mm, and still more preferably 35 μm to 3 mm from the viewpoint of improving the handleability of the powdery and/or granular material.

The median diameter of the powdery and/or granular material may be 20 μm or more and 1000 μm or less. In this case, the powdery and/or granular material can be referred to as “powder”. The lower limit of the median diameter may be 30 μm or more. The median diameter may be up to 500 μm, up to 300 μm, up to 200 μm, or up to 100 μm.

The median diameter of the powdery and/or granular material may be measured in a state where the powdery and/or granular material is dried, or may be measured using a dispersion in which the powdery and/or granular material is dispersed in an aqueous solvent. When the powdery and/or granular material tends to easily aggregate in an aqueous solvent, it is preferable to add the powdery and/or granular material to the aqueous solvent to which a small amount of the dispersant described above is added and stir the mixture, and perform the measurement in a state where the powdery and/or granular material is not aggregated. The measurement device to be used for the measurement in a dry state can be a commonly-used measurement device, one example of which is LMS-3000 manufactured by Seishin Enterprise Co., Ltd. The measurement device to be used for the measurement in a state where the powdery and/or granular material is dispersed in an aqueous solvent can be a commonly-used measurement device, one example of which is Microtrac MT3300 EXII manufactured by Nikkiso Co., Ltd. More specifically, in the integrated distribution of the particle diameter obtained by the measurement, the particle diameter at the point where the larger side and the smaller side are equal in amount (50%) is taken as the “median diameter (D50)”.

The powdery and/or granular material according to the present embodiment preferably has a low water content. Specifically, the water content is preferably 5 wt % or less, more preferably 3 wt % or less, and still more preferably 1 wt % or less.

<Method for Producing Powdery and/or Granular Material>

The method for producing the powdery and/or granular material according to the present embodiment is not particularly limited. However, by preparing an aqueous dispersion including crosslinked resin particles (A) and an aggregation inhibitor (B), separating a mixture of the crosslinked resin particles (A) and the aggregation inhibitor (B) from the aqueous dispersion, and removing water from the separated mixture of the crosslinked resin particles (A) and the aggregation inhibitor (B), it is possible to obtain a powdery and/or granular material including the crosslinked resin particles (A) and the aggregation inhibitor (B).

The method for separating the mixture of the crosslinked resin particles (A) and the aggregation inhibitor (B) from the aqueous dispersion is not particularly limited, and for example, filtration, centrifugation, heat drying, freeze drying, or spray drying can be used. For example, when spray drying is used, dried crosslinked resin particles (A) and aggregation inhibitor (B), that is, a powdery and/or granular material can be directly acquired from the aqueous dispersion.

In addition, by feeding the mixture of the crosslinked resin particles (A) and the aggregation inhibitor (B) separated from the aqueous dispersion, to an extruder and extruding the mixture, it is also possible to acquire a powdery and/or granular material including the crosslinked resin particles (A) and the aggregation inhibitor (B) in a pellet form while completely removing residual moisture.

In addition, an aggregation step by using a coagulant and/or adjusting the pH may be conducted.

The aqueous dispersion including the crosslinked resin particles (A) and the aggregation inhibitor (B) can be prepared by adding the aggregation inhibitor (B) to an aqueous dispersion of the crosslinked resin particles (A). The aqueous dispersion of the crosslinked resin particles (A) can be produced as described above.

When the aggregation inhibitor (B) is insoluble in water, the volume mean diameter of the aggregation inhibitor (B) in the aqueous dispersion is preferably in a range of 0.01 μm or more and 20 μm or less. By virtue of using the aggregation inhibitor (B) having such a particle diameter, a powdery and/or granular material having a particle diameter in a specific range according to the present embodiment can be suitably produced. The particle diameter is preferably at least 0.01 μm, more preferably at least 0.02 μm, and still more preferably at least 0.03 μm. The particle diameter is preferably up to 15 μm, more preferably up to 10 μm, and still more preferably up to 8 μm.

When the aggregation inhibitor (B) is an inorganic component, the inorganic component as a solid may be added to the aqueous dispersion of the crosslinked resin particles (A), or the inorganic component may be made into an aqueous dispersion and then added to the aqueous dispersion of the crosslinked resin particles (A). The volume mean diameter of the inorganic component after being dispersed in water is preferably 0.01 μm to 20 μm as described above.

The method for preparing the aqueous dispersion of the inorganic component is not particularly limited, but a commercially available aqueous dispersion may be used, or an aqueous dispersion obtained by adding an inorganic component to water, and then subjecting the mixture to shearing with a homogenizer or the like to finely disperse the inorganic component may be used. In preparing the aqueous dispersion, temperature adjustment, pH adjustment, and the like may be conducted.

To prepare a stable aqueous dispersant, a dispersant may be used. As the dispersant, the dispersant described above for the “aqueous dispersion of uncrosslinked resin particles” and the like can be used. One of these dispersants may be used alone, or two or more thereof may be used in combination. When a dispersant is used, the amount of the dispersant added is not limited to a particular range and may be, for example, from 0.1 to 10 parts by weight per 100 parts by weight of the inorganic component. The amount of the dispersant is preferably from 0.5 to 5 parts by weight, and particularly preferably from 0.5 to 3 parts by weight per 100 parts by weight of the inorganic component.

When the aggregation inhibitor (B) is an organic compound, the organic compound may be added as it is to the aqueous dispersion of the crosslinked resin particles (A), or the organic compound may be made into an aqueous dispersion and then added to the aqueous dispersion of the crosslinked resin particles (A).

The method for preparing the aqueous dispersion of the organic compound is not particularly limited, but a commercially available aqueous dispersion may be used, or an aqueous dispersion obtained by adding an organic compound to water, and then dispersing the organic compound by conducting stirring, temperature adjustment, pH adjustment, or the like may be used.

To prepare a stable aqueous dispersant, a dispersant may be used. As the dispersant, the dispersant described above for the “aqueous dispersion of uncrosslinked resin particles” and the like can be used. One of these dispersants may be used alone, or two or more thereof may be used in combination. When a dispersant is used, the amount of the dispersant added is not limited to a particular range and may be, for example, from 0.1 to 10 parts by weight per 100 parts by weight of the organic compound. The amount of the dispersant is preferably from 0.5 to 5 parts by weight, and particularly preferably from 0.5 to 3 parts by weight per 100 parts by weight of the organic compound.

The aqueous medium included in the aqueous dispersion including the crosslinked resin particles (A) and the aggregation inhibitor (B) may consist only of water or may be a solvent mixture of water and a water-miscible organic solvent. In the solvent mixture, the concentration of the water-miscible organic solvent is not limited to a particular range and may be any value equal to or lower than the solubility in water of the organic solvent used.

The organic solvent is not limited to a particular solvent, and examples thereof include alcohols such as methanol, ethanol, 1-propanol, 2-propanol, 1-butanol, 2-butanol, isobutanol, pentanol, hexanol, and heptanol; ketones such as acetone and methyl ethyl ketone; ethers such as tetrahydrofuran and dioxane; nitriles such as acetonitrile and propionitrile; amides such as dimethylformamide and acetamide; dimethyl sulfoxide; pyridine; and piperidine. Among these, methanol, ethanol, 1-propanol, 2-propanol, 1-butanol, 2-butanol, isobutanol, acetone, methyl ethyl ketone, tetrahydrofuran, dioxane, acetonitrile, and propionitrile are preferred since they are easy to remove. Methanol, ethanol, 1-propanol, 2-propanol, butanol, and acetone are more preferred because they are easily available. Particularly preferred are methanol, ethanol, and acetone.

The proportion of water in the entire aqueous medium contained in the aqueous dispersion including the crosslinked resin particles (A) and the aggregation inhibitor (B) is preferably 5 wt % or more, more preferably 10 wt % or more, still more preferably 30 wt % or more, even still more preferably 50 wt % or more, and particularly preferably 70 wt % or more. The proportion of water may be 90 wt % or more, or 95 wt % or more. The upper limit of the proportion of water is not limited to a particular value, and may be 100 wt % or less.

The total concentration of the crosslinked resin particles (A) and the aggregation inhibitor (B) in the aqueous dispersion including the crosslinked resin particles (A) and the aggregation inhibitor (B) is not limited to a particular range, but is preferably 10 wt % or more, more preferably 15 wt % or more, and still more preferably 20 wt % or more because, for example, it is economically advantageous in a drying utility aspect and productivity is improved. The upper limit of the total concentration is preferably 65 wt % or less and more preferably 60 wt % or less in order to secure the fluidity of the aqueous dispersion. The method for adjusting the total concentration is not limited to a particular method, and examples thereof include a method of adding an aqueous medium and a method of removing a part of the aqueous medium (for example, after centrifugation, the supernatant is removed).

The pH of the aqueous dispersion including the crosslinked resin particles (A) and the aggregation inhibitor (B) is preferably adjusted to 8 or less, preferably 7 or less, and more preferably 6 or less, as necessary, for example, to suppress a decrease in the molecular weight of the resin component during spray drying and in the processing step after drying. The lower limit of the pHis preferably 1 or more, more preferably 2 or more, and still more preferably 3 or more from the viewpoint of the acid resistance of a container. The method for adjusting the pH is not limited to a particular method, and examples thereof include a method of adding an acid. The acid is not particularly limited, and may be either an organic acid or an inorganic acid. More specifically, examples of an acid that can be used include sulfuric acid, hydrochloric acid, phosphoric acid, and acetic acid.

The aqueous dispersion including the crosslinked resin particles (A) and the aggregation inhibitor (B) may contain one or more of a dispersant or an emulsifier, a pH adjuster, an inorganic filler, a colorant such as a pigment or a dye, an odor absorber such as activated carbon or zeolite, a fragrance such as vanillin or dextrin, a plasticizer, an antioxidant, an anti-oxidizing agent, a weather resistance improver, an ultraviolet absorber, a nucleating agent, a lubricant, a mold release agent, a water repellent, an antibacterial agent, a slidability improver, and the like as long as the effect of the invention is not impaired.

The aqueous dispersion including the crosslinked resin particles (A) and the aggregation inhibitor (B) may contain various components resulting from the process of the production method as long as the effects of the invention are not impaired.

In the aqueous dispersion including the crosslinked resin particles (A) and the aggregation inhibitor (B), the crosslinked resin particles (A), the aggregation inhibitor (B), and the aqueous medium are main constituents. Specifically, the total proportion of the crosslinked resin particles (A) and the aggregation inhibitor (B) in the total solid content of the aqueous dispersion usually may be from 60 to 100 wt %, from 80 to 100 wt %, from 90 to 100 wt %, from 95 to 100 wt %, or from 99 to 100 wt %. The upper limit may be 99 wt % or less, or 95 wt % or less.

The powdery and/or granular material according to the present embodiment can be suitably produced by spray drying the aqueous dispersion including the crosslinked resin particles (A) and the aggregation inhibitor (B) described above.

Examples of the spray drying method include a method in which an aqueous dispersion is fed in the form of fine droplets into a dryer and dried while being brought into contact with hot air in the dryer. The method (atomizer) for feeding the aqueous dispersion in the form of fine droplets into the dryer is not particularly limited, and examples thereof include known methods such as a method using a rotary disk and a method using a nozzle. The type of contact between the droplets and the hot air in the dryer is not particularly limited, and examples thereof include a parallel flow type, a counterflow type, and a type combining those types.

The drying temperature at the time of spray drying may be any temperature at which most of the aqueous medium can be removed from the droplets of the aqueous dispersion. The aqueous dispersion may be dried to a target water content, which may be appropriately set under conditions such that deterioration in quality (decrease in molecular weight, deterioration in color tone, etc.), melting, and the like are not caused as much as possible. For example, the temperature of hot air blown into the spray dryer may be appropriately selected in the range of from 40 to 300° C. The amount of hot air in the dryer may also be appropriately set according to, for example, the size of the dryer.

<Application of Powdery and/or Granular Material>

The application of the powdery and/or granular material according to the present embodiment is not limited to a particular application, and the powdery and/or granular material can be used in applications where conventionally known crosslinked resin particles are used. Specific examples thereof include, but are not limited to, a resin modifier, a rheology modifier of a paint or an adhesive, a paint pigment, a paper coating agent, a matting agent, an anti-blocking agent, an additive for cosmetics, an additive for toner, a spacer for liquid crystal, a coating agent, a filler for adhesive tape, a fiber processing agent, inspection particles for medical diagnosis, and a filler.

The powdery and/or granular material according to the present embodiment may be processed into an article other than the powdery and/or granular material. Such an article is not particularly limited, and examples thereof include granules and molded articles described later. Therefore, one aspect of the present disclosure also extends to a resin composition including crosslinked resin particles (A) and an aggregation inhibitor (B), in which the crosslinked resin particles (A) include a polyhydroxyalkanoate resin and have a gel fraction of 50% or more. The details of the crosslinked resin particles (A) and the aggregation inhibitor (B) and the proportions of both the components can be according to the preceding description.

The shape of the granules obtained by processing the resin composition according to the present disclosure is not limited to a particular shape, and may be, for example, a substantially spherical shape, a flat shape, a cubic shape, a spindle shape, a needle shape, or the like. The median diameter of the granules is not limited to a particular range, but may be, for example, about 1 mm to about 10 mm. The granules may be pellets.

In the case where the powdery and/or granular material according to the present embodiment has been processed into granules, there are advantages of preventing classification when a thermoplastic resin (C) described later is in the form of pellets and mixed with the granules, and preventing clinging to a screw in a kneading machine. Examples of the production method for processing the powdery and/or granular material according to the present embodiment into granules include, but are not limited to, a method involving melting the powdery and/or granular material with an extruder, extruding the melt, and cutting the extrudate with a blade.

From the powdery and/or granular material according to the present embodiment, a molded article can also be produced. The molded article can be expected to improve mechanical properties such as impact resistance or tear strength due to containing the crosslinked resin particles (A). The powdery and/or granular material according to the present embodiment may be used alone to produce a molded article, or may be mixed with an optional additive and/or the thermoplastic resin (C), and then subjected to the production of a molded article. At the time of mixing the powdery and/or granular material with an optional additive or the thermoplastic resin (C), it is preferable to obtain a thermoplastic resin composition by a melt-kneading step and then produce a molded article.

The thermoplastic resin composition can be produced by a known method. A specific example is a method in which the powdery and/or granular material according to the present embodiment is melted and kneaded together with the thermoplastic resin (C) and/or an optional additive by using a device such as an extruder, a kneader, a Banbury mixer, or a roll mill. In the melting and kneading, the components are preferably mixed with care so as to avoid a reduction in molecular weight caused by thermal decomposition. Alternatively, the thermoplastic resin composition can also be produced by dissolving the components in a soluble solvent and then removing the solvent.

As the optional additive, the additive described above as those which may be contained by the powdery and/or granular material according to the present embodiment may be used.

The thermoplastic resin (C) is not particularly limited as long as it is a resin that can be formed into a desired shape by being melted by heating and then being cooled and solidified. Examples thereof include polyolefin resins such as polyethylene and polypropylene; polyvinyl chloride; polystyrene; polyvinyl acetate; polyurethane; polytetrafluoroethylene; acrylic resins such as poly(methyl methacrylate); AS resins; polyamide; polyacetal; polycarbonate; modified polyphenylene ether; polyester resins; and cyclic polyolefin. One of these thermoplastic resins may be used alone, or two or more thereof may be used in combination. The thermoplastic resin (C) preferably has a gel fraction of less than 50%. The thermoplastic resin (C) is preferably a resin that is not crosslinked.

The thermoplastic resin (C) is particularly preferably a polyester resin because a polyester resin has good compatibility with the crosslinked resin particles (A) including a polyhydroxyalkanoate resin. Examples of the polyester resin include PHAs such as polyglycolic acid, poly(3-hydroxyalkanoate) resins, and poly(4-hydroxyalkanoate) resins; polylactic acid; aliphatic polyesters such as a polyester having a structure resulting from polycondensation of an aliphatic diol and an aliphatic dicarboxylic acid; and aliphatic-aromatic polyesters formed using both an aliphatic compound and an aromatic compound as monomers. Examples of the aliphatic polyesters other than PHAs include polycaprolactone, polyethylene succinate, polybutylene succinate (PBS), polyhexamethylene succinate, polyethylene adipate, polybutylene adipate, polyhexamethylene adipate, polybutylene succinate adipate (PBSA), polyethylene sebacate, and polybutylene sebacate. Examples of the aliphatic-aromatic polyesters include poly(butylene adipate-co-butylene terephthalate) (PBAT), poly(butylene sebacate-co-butylene terephthalate), poly(butylene azelate-co-butylene terephthalate), poly(butylene succinate-co-butylene terephthalate) (PBST), and polyethylene furanoate. One of these polyester resins may be used alone, or two or more thereof may be used in combination.

Since the crosslinked resin particles (A) include a PHA having biodegradability, the thermoplastic resin (C) preferably also includes a biodegradable resin. In this case, the biodegradability of the thermoplastic resin composition as a whole can be enhanced.

When the crosslinked resin particles (A) are those produced from a plant-derived raw material, it is preferable, in terms of resources recycling, that the thermoplastic resin (C) be also a resin produced from a plant-derived raw material.

When the thermoplastic resin (C) includes a biodegradable resin, the proportion of the biodegradable resin in the total thermoplastic resin (C) is preferably from 10 to 100 wt %, more preferably 30 wt % or more, even more preferably 50 wt % or more, still even more preferably 70 wt % or more, and particularly preferably 90 wt % or more.

The biodegradable resin used as the thermoplastic resin (C) preferably includes the aliphatic polyester described above, and particularly preferably includes a PHA and/or polylactic acid because such a biodegradable resin has good compatibility with the crosslinked resin particles (A) and is excellent in the effect of improving impact resistance and/or tear strength by the powdery and/or granular material according to the present embodiment. The PHA used as the thermoplastic resin (C) preferably has no crosslinked structure.

When the thermoplastic resin (C) includes a PHA and/or polylactic acid, the proportion of the PHA and/or polylactic acid in the total thermoplastic resin (C) is preferably from 10 to 100 wt %, more preferably 30 wt % or more, even more preferably 50 wt % or more, still even more preferably 70 wt % or more, and particularly preferably 90 wt % or more.

When the thermoplastic resin (C) includes both a PHA and polylactic acid, the weight ratio of PHA:polylactic acid is not particularly limited, but is preferably 10:90 to 90:10, and more preferably 20:80 to 80:20.

The PHA that can be used as the thermoplastic resin (C) is not particularly limited, and examples thereof include polyglycolic acid, P3HAs, and poly(4-hydroxyalkanoate) resins. One PHA may be used alone or two or more PHAs may be used in combination. P3HAs are particularly preferred.

P3HAs that can be used as the thermoplastic resin (C) include those that can be used for the crosslinked resin particles (A), and any of the various P3HAs previously described can be used as the thermoplastic resin (C). The P3HA used as the thermoplastic resin (C) is preferably different from the P3HA used for the crosslinked resin particles (A) and more preferably a resin harder than the P3HA used for the crosslinked resin particles (A).

When the P3HA used as the thermoplastic resin (C) contains 3-hydroxybutyric acid (3HB) repeating units, it is preferable, in terms of the balance of flexibility and strength, that the proportion of the 3HB repeating units be from 80 to 99 mol % and more preferably from 82 to 97 mol % in total monomer repeating units (100 mol %). When the proportion of the 3HB repeating units is 80 mol % or more, the stiffness of the P3HA can be enhanced. When the proportion of the 3HB repeating units is 99 mol % or less, the flexibility of the P3HA is likely to be enhanced. Two or more P3HAs differing in the proportion of the 3HB repeating units may be used in combination.

The molecular weight of the PHA used as the thermoplastic resin (C) is not limited to a particular range. The weight-average molecular weight of the PHA is preferably from 50,000 to 3,000,000, more preferably from 100,000 to 2,000,000, and even more preferably from 150,000 to 1,500,000. When the weight-average molecular weight is 50,000 or more, the thermoplastic resin composition according to the present embodiment can achieve good stiffness or strength. On the other hand, when the weight-average molecular weight is 3,000,000 or less, production and handling of PHA can be facilitated.

The polylactic acid used as the thermoplastic resin (C) can be conventionally known polylactic acid and may be either crystalline or amorphous.

The polylactic acid may be a homopolymer of lactic acid or a copolymer of lactic acid and another monomer. The polylactic acid may be a blend of the homopolymer and the copolymer.

Examples of the other monomer include aliphatic hydroxycarboxylic acids other than lactic acid, aliphatic polyhydric alcohols, aliphatic polycarboxylic acids, and polyfunctional polysaccharides.

The lactic acid raw material for producing the polylactic acid is not limited to a particular material, L-Lactic acid, D-lactic acid, DL-lactic acid, a mixture of these lactic acids, L-lactide, D-lactide, meso-lactide, or a mixture of these lactides can be used. Lactic acid obtained by microbial fermentation of a plant-derived renewable raw material such as starch is suitable for use.

The production of the polylactic acid is not limited to using a particular method, and any known method such as dehydration polycondensation or ring-opening polymerization can be used.

The molecular weight of the polylactic acid used as the thermoplastic resin (C) is not limited to a particular range. The weight-average molecular weight of the polylactic acid is preferably from 50,000 to 1,000,000, more preferably from 70,000 to 700,000, and even more preferably from 100,000 to 400,000. When the weight-average molecular weight is 50,000 or more, the thermoplastic resin composition according to the present embodiment can achieve good stiffness or strength. When the weight-average molecular weight is 1,000,000 or less, production and handling of the polylactic acid can be facilitated.

The content of the thermoplastic resin (C) in the thermoplastic resin composition can be appropriately determined from the viewpoint of, for example, improving mechanical properties such as impact resistance and tear strength, and is preferably from 40 to 99 wt % of the total amount of the powdery and/or granular material according to the present embodiment and the thermoplastic resin (C). Within this range, the impact resistance and/or tear strength of the thermoplastic resin (C) can be improved. The content of the thermoplastic resin (C) may be from 45 to 95 wt %, from 47 to 93 wt %, from 50 to 90 wt %, from 55 to 85 wt %, from 55 to 80 wt %, from 55 to 75 wt %, or from 55 to 70 wt % of that total amount. The content of the thermoplastic resin (C) may be 60 wt % or more, 70 wt % or more, 80 wt % or more, 85 wt % or more, 88 wt % or more, or 90 wt % or more of that total amount.

The proportion of the crosslinked resin particles (A) in the thermoplastic resin composition can be appropriately determined from the viewpoint of, for example, improving mechanical properties such as impact resistance and tear strength, and is preferably from 1 to 60 wt % of the total amount of the powdery and/or granular material according to the present embodiment and the thermoplastic resin (C). Within this range, the impact resistance and/or tear strength of the thermoplastic resin (C) can be improved. The proportion of the crosslinked resin particles (A) may be 5% by weight or more, 7% by weight or more, 10% by weight or more, 15% by weight or more, 20% by weight or more, 25% by weight or more, or 30% by weight or more of that total amount. The proportion of the crosslinked resin particles (A) is preferably 55 wt % or less, more preferably 53 wt % or less, still more preferably 50 wt % or less of that total amount. The proportion of the crosslinked resin particles (A) may be 45 wt % or less, 40 wt % or less, 30 wt % or less, 20 wt % or less, 15 wt % or less, 12 wt % or less, or 10 wt % or less.

The proportion of the aggregation inhibitor (B) in the thermoplastic resin composition can be appropriately determined from the viewpoint of inhibiting adhesion or aggregation of the crosslinked resin particles (A) and the viewpoint of, for example, improving mechanical properties such as impact resistance and tear strength, and is preferably 0.01 to 20 wt % of the total amount of the powdery and/or granular material according to the present embodiment and the thermoplastic resin (C). Within this range, it is possible to improve the impact resistance and/or tear strength of the thermoplastic resin (C) while reducing or inhibiting adhesion or aggregation of the crosslinked resin particles (A). The proportion of the aggregation inhibitor (B) may be from 0.05 to 15 wt %, from 0.1 to 12 wt %, from 0.2 to 10 wt %, or from 0.5 to 8 wt % of that total amount.

### <Nucleating Agent>

The thermoplastic resin composition may further include a nucleating agent. Thanks to the fact that the thermoplastic resin composition includes a nucleating agent, when the thermoplastic resin (C) is a crystalline resin, crystallization during molding processing is promoted, so that molding processability, productivity, and the like can be improved. When the thermoplastic resin composition includes a nucleating agent, there is also an advantage that a thermoplastic resin composition excellent in heat resistance or mechanical properties and a molded article thereof can be obtained.

The nucleating agent is not particularly limited, and conventionally known nucleating agents can be used. Examples of the nucleating agent include inorganic substances such as talc, kaolinite, montmorillonite, mica, synthetic mica, clay, zeolite, silica, carbon black, graphite, boron nitride, zinc oxide, titanium oxide, tin oxide, calcium carbonate, magnesium carbonate, aluminum oxide, neodymium oxide, barium sulfate, sodium chloride, and metal phosphates; sugar alcohol compounds derived from natural products such as erythritol, pentaerythritol, galactitol, mannitol, and arabitol; polysaccharides such as chitin and chitosan; polyols such as aliphatic alcohols (polyols), polyvinyl alcohol, and polyethylene oxide; organic carboxylic acid metal salts such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanoate, calcium montanoate, sodium toluate, sodium salicylate, potassium salicylate, zinc salicylate, aluminum dibenzoate, potassium dibenzoate, lithium dibenzoate, sodium β-naphthalate, and sodium cyclohexanecarboxylate; organic sulfonic acid salts such as sodium p-toluenesulfonate and sodium sulfoisophthalate; carboxylic acid amides such as ethylene sstearamide, ethylene bislauramide, palmitamide, hydroxystearamide, erucamide, and trimesic acid tris(t-butylamide), carboxylic acid esters such as lauric acid esters, palmitic acid esters, oleic acid esters, stearic acid esters, erucic acid esters, N-oleylpalmitic esters, N-oleyloleic esters, N-oleylstearic esters, N-stearyloleic esters, N-stearylstearic esters, N-stearylerucic esters, methylene bisstearic esters, ethylene bislauric esters, ethylene biscapric esters, ethylene bisoleic esters, ethylene bisstearic esters, ethylene biserucic esters, ethylene bisisostearic esters, butylene bisstearic esters, and p-xylylene bisstearic esters; dicarboxylic acid derivatives such as dimethyl adipate, dibutyl adipate, diisodecyl adipate, and dibutyl sebacate; cyclic compounds having, in a molecule, a functional group C═O and one or more functional groups selected from the group consisting of NH, S, and O such as indigo, quinacridone, and quinacridone magenta; sorbitol derivatives such as bisbenzylidene sorbitol and bis(p-methylbenzylidene) sorbitol; compounds containing a nitrogen-containing heteroaromatic core such as pyridine, triazine, and imidazole; phosphoric acid ester compounds, bisamides of higher fatty acids, and metal salts of higher fatty acids; branched polylactic acid; and low molecular weight poly(3-hydroxybutyrate). These nucleating agents may be used alone, or two or more nucleating agents may be used in combination.

The content of the nucleating agent is not particularly limited as long as the crystallization of the thermoplastic resin (C) can be promoted. The content of the nucleating agent is preferably 0.05 to 12 parts by weight, more preferably 0.10 to 10 parts by weight, and still more preferably 0.50 to 8 parts by weight per 100 parts by weight of the thermoplastic resin (C). When the content of the nucleating agent is within the above range, it is possible to obtain an effect as a nucleating agent while inhibiting deterioration in viscosity during molding processing and physical properties of a molded article.

### <Lubricant>

The thermoplastic resin composition may further include a lubricant. When the thermoplastic resin composition includes a lubricant, the surface smoothness of a resulting molded article can be improved.

The lubricant is not particularly limited. Examples of the lubricant include, but are not limited to, fatty acid metal salts such as magnesium stearate and calcium stearate; fatty acid amides such as behenamide, stearamide, erucamide, oleamide, methylene bisstearamide, and ethylene bisstearamide; polyethylene wax, oxidized polyester wax, glycerin monofatty acid esters such as glycerin monostearate, glycerin monobehenate, and glycerin monolaurate; organic acid monoglycerides such as succinylated monoglycerides of saturated fatty acids; sorbitan fatty acid esters such as sorbitan behenate, sorbitan stearate, and sorbitan laurate; polyglycerin fatty acid esters such as diglycerin stearate, diglycerin laurate, tetraglycerin stearate, tetraglycerin laurate, decaglycerin stearate, and decaglycerin laurate; and higher alcohol fatty acid esters such as stearyl stearate. One lubricant may be used alone, or two or more lubricants may be used in combination.

The content of the lubricant (when two or more lubricants are used, the total content of the lubricants) is not limited to a particular range as long as the lubricant(s) can provide lubricity to a molded article. The content of the lubricant is preferably 0.01 to 20 parts by weight, more preferably 0.05 to 10 parts by weight, still more preferably 0.10 to 10 parts by weight, even more preferably 0.20 to 5 parts by weight, and particularly preferably 0.30 to 4 parts by weight per 100 parts by weight of the thermoplastic resin (C). When the content of the lubricant is in the above range, the effect of the lubricant can be obtained while avoiding bleeding out of the lubricant to the surface of a molded article.

### <Other Components>

The thermoplastic resin composition may contain other components such as a plasticizer, an organic filler, an inorganic filler, an antioxidant, a hydrolysis inhibitor, an ultraviolet absorber, a colorant such as a dye or a pigment, and an antistatic agent as long as the function of the resulting molded article is not impaired.

The plasticizer is not particularly limited. Examples of the plasticizer include polyester-based plasticizers such as polypropylene glycol sebacate; aliphatic dibasic acid ester-based plasticizers such as di-1-butyl adipate, di-n-butyl sebacate, and di-2-ethylhexyl azelate; glycerin-based plasticizers such as glycerin diacetomonolaurate, glycerin diacetomonocaprylate, and glycerin diacetomonodecanoate; polyvalent carboxylic acid ester-based plasticizers such as tri-2-ethylhexyl acetylcitrate and tributyl acetylcitrate; polyalkylene glycol-based plasticizers such as polyethylene glycol, polypropylene glycol, poly(ethylene oxide-propylene oxide) block and/or random copolymers, and polytetramethylene glycol; phosphoric acid ester-based plasticizers such as diphenyl 2-ethylhexyl phosphate and diphenyl octyl phosphate; epoxy-based plasticizers such as epoxidized soybean oil and epoxidized linseed oil fatty acid butyl ester; and castor oil-based plasticizers such as castor oil fatty acid ester, methyl ricinolate, ethyl ricinolate, isopropyl ricinolate, butyl ricinolate, ethylene glycol monoricinoleate, propylene glycol monoricinoleate, trimethylolpropane monoricinoleate, sorbitan monoricinoleate, castor oil fatty acid polyethylene glycol ester, castor oil ethylene oxide adduct, castor oil-based polyol, and castor oil-based toluol or castor oil-based diol. These plasticizers may be used alone, or two or more plasticizers may be used in combination.

The organic filler is not particularly limited. Examples of the organic filler include fillers composed of naturally occurring materials such as woody materials (for example, wood debris, wood powder, and sawdust), rice chaff, rice powder, starch, corn starch, rice straw, wheat straw, and natural rubber; organic fibers such as plant-derived natural fibers, animal-derived natural fibers, and synthetic fibers; and fillers made of synthetic resin materials such as polyesters, polyacrylic polymers, polyamides, nylon, polyethylene, polyolefins, polyvinyl alcohol, polyvinyl chloride, polyurethane, polyacetal, aramid, PBO (poly-p-phenylenebenzobisoxazole), polyphenylene sulfide, acetylcellulose, polybenzazole, polyarylate, polyvinyl acetate, and synthetic rubber.

The plant-derived natural fiber is not particularly limited. Examples of the plant-derived natural fiber include kenaf fiber, abaca fiber, bamboo fiber, jute fiber, hemp fiber, linen fiber, henequen (sisal hemp), ramie fiber, hemp, cotton, banana fiber, coconut fiber, palm, palm, paper mulberry, oriental paperbush, and bagasse. Examples of the plant-derived natural fiber further include regenerated fibers, such as pulp, cellulose fiber, and rayon, processed from plant fibers. Examples of the animal-derived natural fiber include wool, silk, cashmere, and mohair.

The inorganic filler is not particularly limited. Examples of the inorganic filler include silica-based inorganic fillers (for example, quartz, fumed silica, silicic anhydride, molten silica, crystalline silica, amorphous silica, a filler obtained by condensation of alkoxysilane, and ultrafine amorphous silica), alumina, zircon, iron oxide, zinc oxide, titanium oxide, silicon nitride, boron nitride, aluminum nitride, silicon carbide, glass, silicone rubber, silicone resin, titanium oxide, carbon fiber, mica, black lead, carbon black, ferrite, graphite, diatomite, white clay, clay, talc, calcium carbonate, manganese carbonate, magnesium carbonate, barium sulfate, and silver powder. These inorganic fillers may be surface-treated in order to improve dispersibility in the resin composition. These inorganic fillers may be used alone, or two or more inorganic fillers may be used in combination.

The antioxidant is not particularly limited. Examples of the antioxidant include phenol-based antioxidants, phosphorus-based antioxidants, and sulfur-based antioxidants. These antioxidants may be used alone, or two or more antioxidants may be used in combination.

The hydrolysis inhibitor is not particularly limited. Examples of the hydrolysis inhibitor include carbodiimide compounds, epoxy compounds, isocyanate compounds, and oxazoline compounds. These hydrolysis inhibitors may be used alone, or two or more hydrolysis inhibitors may be used in combination.

The ultraviolet absorber is not particularly limited. Examples of the ultraviolet absorber include benzophenone-based compounds, benzotriazole-based compounds, triazine-based compounds, salicylic acid-based compounds, cyanoacrylate-based compounds, and nickel complex salt-based compounds. These ultraviolet absorbers may be used alone, or two or more ultraviolet absorbers may be used in combination.

The colorant such as a pigment or a dye is not particularly limited. Examples of the colorant such as a pigment or a dye include inorganic colorants such as titanium oxide, calcium carbonate, chromium oxide, copper suboxide, calcium silicate, iron oxide, carbon black, graphite, titanium yellow, and cobalt blue; soluble azo pigments such as lake red, lithol red, and brilliant carmine; insoluble azo pigments such as dinitroaniline orange and fast yellow; phthalocyanine pigments such as monochlorophthalocyanine blue, polychlorophthalocyanine blue, and polybromophthalocyanine green; condensed polycyclic pigments such as indigo blue, perylene red, isoindolinone yellow, and quinacridone red; and dyes such as Oracet yellow. These colorants may be used alone, or two or more colorants may be used in combination.

The antistatic agent is not particularly limited. Examples of the antistatic agent include low-molecular-weight antistatic agents such as fatty acid ester compounds, aliphatic ethanolamine compounds, and aliphatic ethanolamide compounds; and high-molecular-weight antistatic agents. These antistatic agents may be used alone, or two or more antistatic agents may be used in combination.

The thermoplastic resin composition can also contain catalyst deactivators (a hindered phenol-based compound, a thioether-based compound, a vitamin-based compound, a triazole-based compound, a polyhydric amine-based compound, a hydrazine derivative-based compound, a phosphorous-based compound, etc.), release agents (montanic acid and salts thereof, esters thereof, half esters thereof, stearyl alcohol, stearamide, polyethylene wax, etc.), coloring inhibitors (phosphite, hypophosphite, etc.), silane coupling agents (epoxy silane coupling agents, amino silane coupling agents, (meth)acrylic silane coupling agents, isocyanate silane coupling agents, etc.), flame retardants (red phosphorus, phosphoric acid esters, brominated polystyrene, brominated polyphenylene ether, brominated polycarbonate, aluminum hydroxide, magnesium hydroxide, melamine and cyanuric acid or a salt thereof, silicon compounds, etc.), conductive agents (carbon black, etc.), slidability improvers (graphite, fluororesin, etc.), epoxy compounds (glycidyl ether compounds, glycidyl ester compounds, polymer compounds obtained by grafting or copolymerizing glycidyl compounds, etc.), acid anhydride compounds (maleic anhydride, succinic anhydride, polymer compounds obtained by grafting or copolymerizing acid anhydrides, etc.), carbodiimide compounds (N,N′-di-2,6-diisopropylphenylcarbodiimide, 2,6,2′,6′-tetraisopropyldiphenylcarbodiimide, polycarbodiimide, etc.), and the like.

The amount of each of the other components described above is not limited to a particular range as long as the effect of an embodiment of the invention can be achieved. The amount of each of the other components can be set appropriately by those skilled in the art. The thermoplastic resin composition can be produced by a known method. A specific example is a method in which the powdery and/or granular material according to the present embodiment, the thermoplastic resin (C) and, as optional components, a nucleating agent, a lubricant, and other components are melted and kneaded together by using a device such as an extruder, a kneader, a Banbury mixer, or a roll mill. In the melting and kneading, the components are preferably mixed with care so as to avoid a reduction in molecular weight caused by thermal decomposition. Alternatively, the thermoplastic resin composition can also be produced by dissolving all raw materials (components) in a soluble solvent and then removing the solvent.

When the thermoplastic resin composition is produced by melting and kneading, each of the components may be individually placed into a device such as an extruder, or the components may be mixed first and then the mixture may be placed into a device such as an extruder. For example, an aqueous dispersion of the thermoplastic resin (C) and an aqueous dispersion of the powdery and/or granular material according to the present embodiment may be mixed, followed by drying the resulting mixed liquid in a dryer to obtain a mixed powder, and charging the mixed powder into an extruder, or the like.

When the melting and kneading are performed by an extruder, the resulting thermoplastic resin composition may be extruded into a strand, and then the strand may be cut into particles of bar shape, cylindrical shape, elliptic cylindrical shape, spherical shape, cubic shape, rectangular parallelepiped shape, or any other shape.

The resin temperature in the melting and kneading depends on the properties such as melting point and melt viscosity of the resins used and cannot be definitely specified. In terms of avoiding thermal decomposition of resin components and at the same time dispersing the powdery and/or granular material according to the present embodiment in the thermoplastic resin (C) uniformly, the resin temperature is preferably from 120 to 250° C., more preferably from 130 to 230° C., and even more preferably from 140 to 220° C.

In one embodiment of the present invention, a molded article produced by molding the thermoplastic resin composition is provided. The method of molding the thermoplastic resin composition is not limited to a particular method, and a commonly used molding method can be employed. Specific examples of the molding method include blown film molding, extrusion molding, calender molding, T-die extrusion molding, casting, rolling, pressing, injection blow molding, vacuum molding, and injection molding.

By conducting the molding method described above using the thermoplastic resin composition, a molded article excellent in impact resistance and/or tear strength, specifically, a sheet molded article, a film molded article, a blown molded article, an extrusion molded article, a vacuum molded article, or an injection molded article can be produced with good productivity.

A film molded article or a sheet molded article according to one embodiment of the present invention is a film molded article or a sheet molded article produced by molding the thermoplastic resin composition described above. The film molded article or sheet molded article has an advantage of having impact resistance and/or tear strength improved by including the above-described configuration. The film molded article or sheet molded article according to one preferred embodiment of the present invention has an advantage of being excellent in tensile elongation at break and tear strength due to including the above-described configuration.

In the present description, the “film molded article” is in accordance with JIS20108: 2012, and specifically is intended to refer to a thin film-shaped article having a thickness of less than 0.25 mm. In the present description, the “sheet molded article” is in accordance with JIS20108: 2012, and specifically is intended to refer to a thin plate-like article having a thickness of 0.25 mm or more.

The molded article formed from the thermoplastic resin composition according to the present embodiment is suitable for use in various fields such as agricultural industry, fishery industry, forestry industry, horticultural industry, medical industry, hygiene industry, food industry, apparel industry, non-apparel industry, packaging industry, automotive industry, building material industry, and other industries.

In the following items, preferred aspects of the present disclosure are listed. The present invention is not limited to the following items.

[Item 1] A powdery and/or granular material having a median diameter of 20 μm to 10 mm, wherein
the powdery and/or granular material includes crosslinked resin particles (A) and an aggregation inhibitor (B),
the crosslinked resin particles (A) include a polyhydroxyalkanoate resin, and have a gel fraction of 50% or more and a volume mean diameter of 0.1 μm or more and 10 μm or less.

[Item 2] The powdery and/or granular material according to item 1, wherein a proportion of the crosslinked resin particles (A) in a total amount of the crosslinked resin particles (A) and the aggregation inhibitor (B) is from 10 to 99.5 wt %.

[Item 3] The powdery and/or granular material according to item 1 or 2, wherein the polyhydroxyalkanoate resin is a poly(3-hydroxyalkanoate) resin.

[Item 4] The powdery and/or granular material according to any one of items 1 to 3, wherein the crosslinked resin particles (A) are resin particles crosslinked using a peroxide.

[Item 5] The powdery and/or granular material according to item 4, wherein the crosslinked resin particles (A) are resin particles crosslinked in the presence of a polyfunctional compound additionally.

[Item 6] The powdery and/or granular material according to any one of items 1 to 5, wherein a proportion of the polyhydroxyalkanoate resin in the crosslinked resin particles (A) is 80 wt % or more.

[Item 7] The powdery and/or granular material according to any one of items 1 to 6, wherein a surface coverage of the crosslinked resin particles (A) with the aggregation inhibitor (B) is 10 to 100%.

[Item 8] The powdery and/or granular material according to any one of items 1 to 7, wherein the aggregation inhibitor (B) is an inorganic component.

[Item 9] The powdery and/or granular material according to any one of items 1 to 8, wherein the aggregation inhibitor (B) is a polyhydric alcohol.

[Item 10] The powdery and/or granular material according to any one of items 1 to 9, wherein the aggregation inhibitor (B) is a polysaccharide.

[Item 11] The powdery and/or granular material according to any one of items 1 to 10, wherein the aggregation inhibitor (B) is an oligosaccharide.

[Item 12] A method for producing the powdery and/or granular material according to any one of items 1 to 11, the method comprising:
preparing an aqueous dispersion including crosslinked resin particles (A) and an aggregation inhibitor (B); and
spray drying the aqueous dispersion.

[Item 13] A thermoplastic resin composition comprising the powdery and/or granular material according to any one of items 1 to 11, and a thermoplastic resin (C).

[Item 14] The thermoplastic resin composition according to item 13, wherein the thermoplastic resin (C) includes a biodegradable resin.

[Item 15] A molded article produced by molding the thermoplastic resin composition according to item 13 or 14.

### EXAMPLES

Hereinafter, the present invention will be described more specifically using examples. The present invention is not limited by the examples in any respect.

### [1] Measurement Conditions

### 1-1. Weight-Average Molecular Weight

The resin as a measurement object was dissolved in chloroform, and the solution was heated in a hot water bath at 60° C. for 30 minutes. The heated solution was filtered through a disposable filter made of PTFE and having a pore diameter of 0.45 μm, and the filtrate was then subjected to GPC analysis under the conditions listed below to determine the weight-average molecular weight.
GPC system: High-performance liquid chromatograph 20A system manufactured by Shimadzu Corporation
Column: K-G 4A (one column) and K-806M (two columns) manufactured by Showa Denko K.K.
Sample concentration: 1 mg/ml
Eluent: Chloroform solution
Eluent flow rate: 1.0 ml/min
Amount of injected sample: 100 μL
Analysis time: 30 minutes
Standard sample: Standard polystyrene

### 1-2. Volume Mean Diameter

The volume mean diameter of crosslinked resin particles, uncrosslinked resin particles, or an aggregation inhibitor was measured for a latex of particles. The measurement device used was Microtrac MT3300 EXII manufactured by Nikkiso Co., Ltd.

### 1-3. Gel Fraction

Crosslinked resin particles having been dried were added to chloroform to give a concentration of 0.7 wt % and dissolved at 60° C. for 30 minutes, affording a chloroform solution. Subsequently, the chloroform solution was allowed to stand at room temperature for 3 hours, after which the chloroform solution was filtered through a membrane filter having a pore diameter of 0.45 μm. During the filtration process, chloroform was poured on the interior of the container and the filter several times to ensure sufficient washing to prevent a loss. The gel remaining on the filter was dried, and the total weight of the dried gel and the filter was measured. The gel fraction was calculated by the following equation.

$$Gel fraction ( \% ) = [ ( weight of filter carrying dried gel - weight of filter alone ) / \\ weight of crosslinked resin particles used for measurement ] \times 100$$

### [2] Raw Materials for Crosslinked Resin Particles

### 2-1. Uncrosslinked Resin Particles

Poly(3-hydroxybutyrate-co-3-hydroxyhexanoate), (3-hydroxybutyrate)/(3-hydroxyhexanoate)=72/28 (mol/mol), weight-average molecular weight Mw=50×10⁴ to 150×10⁴, volume mean diameter: 1.7 μm

### 2-2. Peroxide

Di-sec-butyl peroxydicarbonate (“Luperox 225” manufactured by ARKEMA Yoshitomi Ltd., one-hour half-life temperature: 69° C.)

### 2-3. Polyfunctional Compound

### Triallyl Isocyanurate

### [3] Method for Preparing Aqueous Dispersion of Crosslinked Resin Particles (A)

A glass container equipped with a stirrer, a baffle, a nitrogen inlet/outlet, and a thermometer was charged with an aqueous dispersion containing the uncrosslinked resin particles dispersed in water (the amount of solids was 100 parts by weight), 200 parts by weight of deionized water, 2 parts by weight of peroxide, 2 parts by weight of sodium dioctyl sulfosuccinate, and 0.5 parts by weight of polyfunctional compound. Stirring of the contents of the glass container was started at room temperature, and at the same time the interior of the glass container was purged with nitrogen.

After that, the contents of the glass container were stirred at room temperature for 1 hour to impregnate the uncrosslinked resin particles with the peroxide and the polyfunctional compound, and then the temperature was raised to 75° C. as a reaction temperature. After the temperature reached the reaction temperature, the reaction was allowed to proceed at the reaction temperature for 3.5 hours. After completion of the reaction, the pH was adjusted to be stable at 3.8 at 50 to 55° C., affording an aqueous dispersion in which crosslinked resin particles (A) were dispersed in water.

The volume mean diameter of the crosslinked resin particles (A) in the aqueous dispersion was measured by the above-described method and found to be 1.7 μm.

In addition, the pH of the aqueous dispersion was adjusted, and then the aqueous dispersion was dried in an oven, affording crosslinked resin particles (A) solidified. The gel fraction of the particles was measured by the above-described method and found to be 95%.

### [4] Method for Preparing Aqueous Dispersion for Spray Drying

(a) Aqueous dispersion of the crosslinked resin particles (A) described above (solid concentration: 25%)
(b-1) Nanosilica aqueous dispersion (SNOWTEX MP2040 manufactured by Nissan Chemical Corporation) particle shape: spherical, volume mean diameter (MV): 150 nm, solid concentration: 37.8%
(b-2) Nanosilica aqueous dispersion (SNOWTEX ZL manufactured by Nissan Chemical Corporation) particle shape: spherical, volume mean diameter (MV): 81 nm, solid concentration: 40.3%
(b-3) Nanosilica aqueous dispersion (SNOWTEX 30 manufactured by Nissan Chemical Corporation) particle shape: spherical, solid concentration: 30.3%
(b-4) Nanosilica aqueous dispersion

A prescribed amount of fumed silica (AEROSIL 50 manufactured by NIPPON AEROSIL CO., LTD.) was added to pure water, and dispersed with an ultrasonic homogenizer, affording a nanosilica aqueous dispersion. Volume mean diameter (MV): 300 nm, solid concentration: 10%.
(b-5) Nanosilica aqueous dispersion

A prescribed amount of fumed silica (AEROSIL OX50 manufactured by NIPPON AEROSIL CO., LTD.) was added to pure water, and dispersed with an ultrasonic homogenizer, affording a nanosilica aqueous dispersion. Volume mean diameter (MV): 300 nm, solid concentration: 10%.
(b-6) Talc aqueous dispersion

A prescribed amount of talc (MICRO ACE K-1 manufactured by Nippon Talc Co., Ltd.) was added to pure water, and the mixture was stirred at normal temperature, affording a talc aqueous dispersion. Volume mean diameter (MV): 10 μm, solid concentration: 20%.
(b-7) Pentaerythritol (Neulizer P manufactured by The Nippon Synthetic Chemical Industry Co., Ltd.)
(b-8) α-Cyclodextrin (reagent manufactured by Tokyo Chemical Industry Co., Ltd.)
(b-9) Aqueous starch solution

A prescribed amount of water-soluble starch (reagent manufactured by FUJIFILM Wako Pure Chemical Corporation) was added to pure water, and the mixture was stirred at normal temperature, affording an aqueous starch solution. Solid concentration: 10%.

The aqueous dispersion (a) was mixed with (b-1) to (b-9) at the proportions (on solid weight basis) shown in Table 1, and then the pH was adjusted to be stable at 3.8. Thus, mixed aqueous dispersions were obtained. Since (b-7) and (b-8) were soluble in water, each solid was added to the aqueous dispersion (a) as it was.

### [5] Spray Drying Method

The mixed aqueous dispersion obtained as described above was spray dried under the conditions shown in Table 1 using an L-8 spray dryer manufactured by Ohkawara Kakohki Co., Ltd., and thus a powdery and/or granular material including the crosslinked resin particles (A) and the aggregation inhibitor (B) was obtained.

### (Median Diameter)

The median diameter of the powdery and/or granular material obtained by spray drying was measured in a dry manner by a laser diffraction/scattering method using LMS-3000 manufactured by Seishin Enterprise Co., Ltd. The results are shown in Table 1.

(Evaluation of State of Powdery and/or Granular Material)

The state of the powdery and/or granular material obtained by spray drying was evaluated on the basis of the following criteria. The results are shown in Table 1.

A: Dry powdery and/or granular material having no adhesive-agglomerative property and high fluidity.

B: Fluid powdery and/or granular material having increased adhesive-agglomerative property.

C: The material is in a powdery and/or granular material state though the adhesive-agglomerative property was further increased, and the fluidity was reduced.

D: The material cannot be made into a powdery and/or granular material.

TABLE 1

| | | Compar- | | | | | | | | |
|---|---|---|---|---|---|---|---|---|---|---|
| | | ative Ex- | Exam- | Exam- | Exam- | Exam- | Exam- | Exam- | Exam- | Exam- |
| | | ample 1 | ple 1 | ple 2 | ple 3 | ple 4 | ple 5 | ple 6 | ple 7 | ple 8 |
| Crosslinked resin | Weight ratio (%) | 100 | 66.7 | 85.7 | 90.91 | 92.3 | 95.2 | 90.91 | 90.91 | 95.2 |
| particles (A) | | | | | | | | | | |
| Aggregation | Type | — | b-1 | | | | | b-2 | b-3 | |
| inhibitor (B) | Weight ratio (%) | — | 33.3 | 14.3 | 9.09 | 7.7 | 4.8 | 9.09 | 9.09 | 4.8 |
| Spray drying | Liquid delivery | — | 0.5 | 0.5 | 0.8 | 0.5 | 0.8 | 0.8 | 0.8 | 0.8 |
| conditions | amount (L/h) | | | | | | | | | |
| | Hot air temperature | — | 80 | 80 | 80 | 80 | 80 | 80 | 80 | 80 |
| | (° C.) | | | | | | | | | |
| | Exhaust air | — | 55 | 55 | 55 | 55 | 55 | 55 | 55 | 55 |
| | temperature (° C.) | | | | | | | | | |
| | Disk rotation speed | — | 20,000 | 20,000 | 15,000 | 20,000 | 15,000 | 15,000 | 15,000 | 15,000 |
| | (rpm) | | | | | | | | | |
| Powdery/granular | Median diameter (μm) | — | 40 | 39 | 37 | 40 | 35 | 38 | 35 | 35 |
| material | State evaluation | D | A | A | A | B | B | A | A | B |
| | | Exam- | Exam- | Exam- | Exam- | Exam- | Exam- | Exam- | Exam- | Exam- |
| | | ple 9 | ple 10 | ple 11 | ple 12 | ple 13 | ple 14 | ple 15 | ple 16 | ple 17 |
| Crosslinked resin | Weight ratio (%) | 90.91 | 90.91 | 66.7 | 90.9 | 96.8 | 98 | 90.91 | 95.2 | 90.91 |
| particles (A) | | | | | | | | | | |
| Aggregation | Type | b-4 | b-5 | b-6 | b-7 | | | b-8 | | b-9 |
| inhibitor (B) | Weight ratio (%) | 9.09 | 9.09 | 33.3 | 9.1 | 3.2 | 2 | 9.09 | 4.8 | 9.09 |
| Spray drying | Liquid delivery | 0.8 | 0.8 | 0.5 | 0.5 | 0.8 | 0.8 | 0.8 | 0.8 | 0.8 |
| conditions | amount (L/h) | | | | | | | | | |
| | Hot air temperature | 80 | 80 | 40 | 80 | 80 | 80 | 80 | 90 | 80 |
| | (° C.) | | | | | | | | | |
| | Exhaust air | 55 | 55 | 30 | 55 | 55 | 55 | 55 | 60 | 55 |
| | temperature (° C.) | | | | | | | | | |
| | Disk rotation speed | 15,000 | 15,000 | 20,000 | 20,000 | 15,000 | 15,000 | 15,000 | 15,000 | 15,000 |
| | (rpm) | | | | | | | | | |
| Powdery/granular | Median diameter (μm) | 35 | 40 | 40 | 40 | 38 | 40 | 39 | 33 | 35 |
| material | State evaluation | B | B | C | A | B | B | A | A | A |

In each of Examples 1 to 17 in Table 1, a powdery and/or granular material including crosslinked resin particles (A) and an aggregation inhibitor (B) was obtained by spray drying a mixed aqueous dispersion including the crosslinked resin particles (A) and the aggregation inhibitor (B). The powdery and/or granular material obtained in each Example had fluidity and was handleable. Among them, the powdery and/or granular materials obtained in Examples 1 to 10 and 12 to 17 were good in terms of fluidity, and in particular, the powdery and/or granular materials of Examples 1 to 3, 6, 7, 12, and 15 to 17 using silica, pentaerythritol, α-cyclodextrin, or starch as the aggregation inhibitor (B) were excellent.

On the other hand, in Comparative Example 1, an attempt was made to spray dry an aqueous dispersion including only crosslinked resin particles (A), but the resin particles adhered to the wall surface inside the spray dryer while being aggregated, so that it was difficult to collect the resin particles, and it was impossible to obtain a powdery and/or granular material like those obtained in the Examples. This fact shows that the crosslinked resin particles (A) have extremely high adhesive-agglomerative property, and are difficult to collect as a sole-constituent powdery and/or granular material.

[6] Micrograph and Surface Coverage of Powdery and/or Granular Material

The powdery and/or granular material obtained in Example 1 was fixed on a sample stage, gold vapor deposition was conducted, and then the powdery and/or granular material was observed using a scanning electron microscope (EF-SEM: manufactured by Hitachi High-Tech Corporation, S-4800) to afford a micrograph. The photograph is shown in FIG. 1. From FIG. 1, it can be seen that the surface of a secondary aggregate of the crosslinked resin particles (A) is covered with fine particles of silica as the aggregation inhibitor (B).

Subsequently, in the photograph, the area was calculated for each of a region where the surface of the secondary aggregate of the crosslinked resin particles (A) was covered with the aggregation inhibitor (B) and a region where the surface of the secondary aggregate of the crosslinked resin particles (A) was exposed, and the surface coverage was calculated from the areas on the basis of the following formula.

$$Surface coverage ( \% ) = [ area of region where surface of secondary aggregate of crosslinked \\ resin particles ( A ) is covered with aggregation inhibitor ( B ) / \\ ( area of region where surface of secondary aggregate of crosslinked \\ resin particles ( A ) is covered with aggregation inhibitor ( B ) + area of region where surface of secondary aggregate \\ of crosslinked resin particles ( A ) is exposed ) ] \times 100$$

As a result, the surface coverage in Example 1 was 100%.

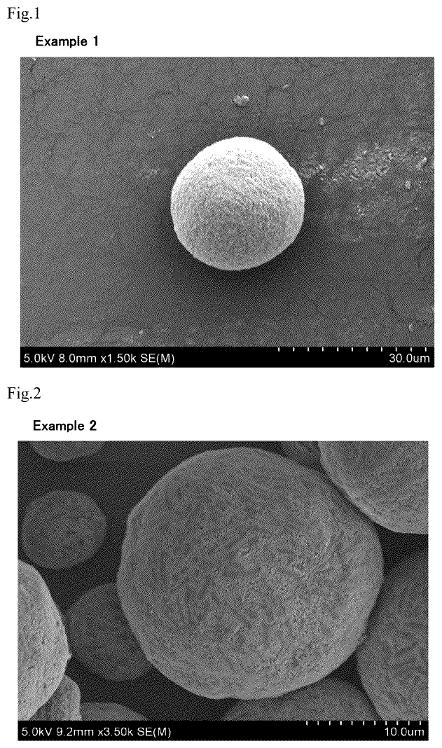

Similarly, the powdery and/or granular materials obtained in Examples 2, 4, 9, 11, 12, and 16 were observed with an electron microscope, and the obtained micrographs are shown in FIGS. 2 to 7.

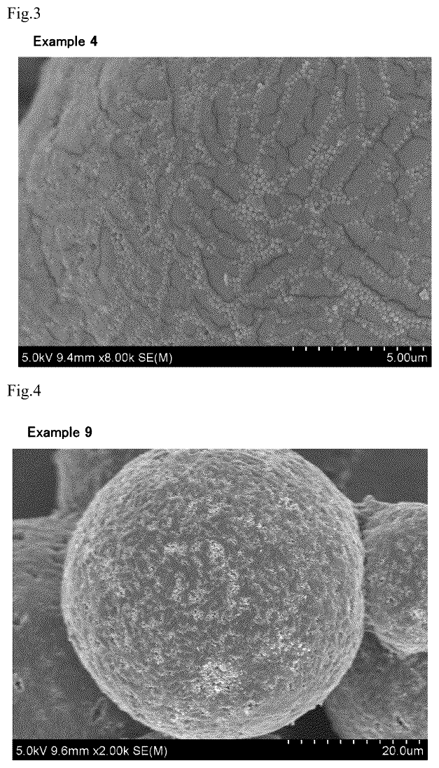

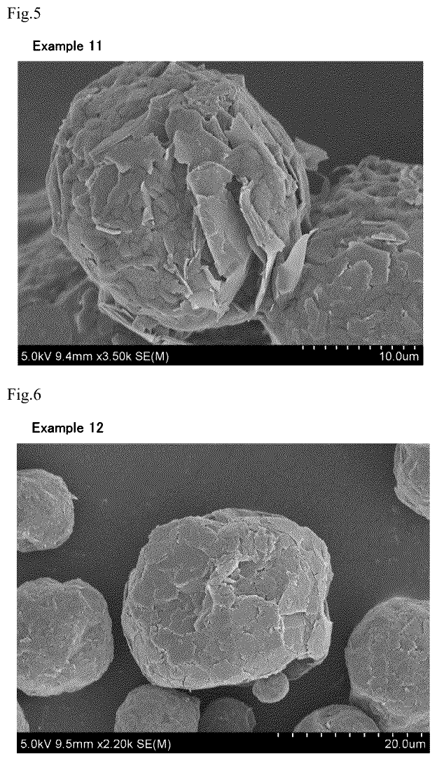

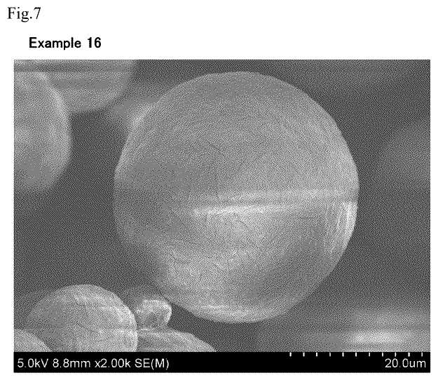

In addition, based on these micrographs, the surface coverage was calculated in the same manner as described above. The results are as follows.
FIG. 2, Example 2: 70%
FIG. 3, Example 4: 30%
FIG. 4, Example 9: 30%
FIG. 5, Example 11: 20%
FIG. 6, Example 12: 100%
FIG. 7, Example 16: 100%

In FIGS. 2 to 4, as in FIG. 1, silica as the aggregation inhibitor (B) is observed as fine particles attached to the surface of the secondary aggregate of the crosslinked resin particles (A). In FIGS. 5 and 6, talc or pentaerythritol as the aggregation inhibitor (B) is observed as a thin plate-like substance. In FIG. 7, it can be seen that the entire surface of the secondary aggregate of the crosslinked resin particles (A) is uniformly coated with α-cyclodextrin as the aggregation inhibitor (B).

### [7] Evaluation of Physical Properties of Thermoplastic Resin Composition

### 7-1. Components of Test Specimen

(a) Thermoplastic resin: blending amounts (parts by weight) shown in Tables 2 to 5
(C-1): Poly(3-hydroxybutyrate-co-3-hydroxyhexanoate (KANEKA Biodegradable Polymer PHBH (registered trademark) manufactured by Kaneka Corporation)), (3-hydroxybutyrate)/(3-hydroxyhexanoate)=94.4/5.6 (mol/mol), weight-average molecular weight Mw: 53× 10⁴
(C-2): PLA, manufactured by Total Corbion PLA, Luminy (registered trademark) LX975
(C-3): PBSA, manufactured by Mitsubishi Chemical Corporation, FD92PB
(b) Powdery and/or granular materials prepared in Examples 1 to 17 or crosslinked resin particles (A): blending amounts (parts by weight) shown in Tables 2 to 5

As the crosslinked resin particles (A), those obtained by solidifying the above-described aqueous dispersion of the crosslinked resin particles (A) by drying in an oven after pH adjustment were used.
(c) Pentaerythritol (Neulizer P manufactured by The Nippon Synthetic Chemical Industry Co., Ltd.): blending amounts (parts by weight) shown in Tables 2 to 5
(d) Behenamide (BNT-22H manufactured by Nippon Fine Chemical Co., Ltd.): 0.5 parts by weight

### 7-2. Method for Preparing Test Specimen

### Method for Preparing Test Specimen in Reference Examples 1 and 4 to 5 and Examples 18 to 23, 25, and 33 to 51

A mixture of the components (a), (b), (c) and (d) was kneaded in a twin-screw kneader (KZW15 TWIN-45WG manufactured by Technovel Corporation) heated to a barrel temperature of 140 to 165° C., at a screw rotation speed of 80 rpm, affording a kneaded product. The kneaded product was dried in a dryer at 80° C. for 4 hours to fully reduce the moisture content of the kneaded product, and then a thermoplastic resin composition was obtained. The obtained thermoplastic resin composition was press-molded at 165° C. to prepare a test specimen having a prescribed thickness.

### Method for Preparing Test Specimen in Reference Examples 2 to 3 and Examples 24 and 26 to 32

A mixture of the components (a), (b), (c), and (d) was melt-kneaded in a twin-screw extruder (TEM-26SS manufactured by Shibaura Machine Co., Ltd.) heated to a barrel temperature of 155° C. at a screw rotation speed of 100 rpm, affording a melt-kneaded product (mixture). The obtained melt-kneaded product was dried at 50° C. for 12 hours in a dehumidifier to fully reduce the moisture content, affording a thermoplastic resin composition. Further, the obtained thermoplastic resin composition was press-molded at 120 to 165° C. to prepare a test specimen having a prescribed thickness.

### 7-3. Measurement of Tensile Impact Strength

A 500-μm-thick sheet prepared as described above was aged at 23° C. and 50% RH for 7 days, and then the sheet was punched to give a test specimen of shape 3 as specified in JIS K 7160. The test specimen was subjected to a tensile impact test in accordance with the method A of JIS K 7160. The results are shown in Tables 2 to 4.

### 7-4. Measurement of Tensile Property

A 200-μm-thick sheet prepared as described above was aged at 23° C. and 50% RH for 7 days, and then the sheet was subjected to the measurement of tensile property with a tensile tester (manufactured by Shimadzu Corporation; EZ-LX 1 kN) at a test speed of 100 mm/min by a method in accordance with JIS K 7133. The results are shown in Tables 2 to 4.

### 7-5. Elmendorf Tear Strength

A 110-μm-thick film prepared as described above was aged at 23° C. and 50% RH for 7 days. Thereafter, the tear strength was measured in accordance with JIS K 7128-2 using a light load type tearing tester (“No. 2037 with special specification” manufactured by Kumagai Riki Kogyo Co., Ltd.) having a function and a structure in accordance with a standard Elmendorf tearing tester specified in JIS K 7128-2. The measured value (N) was divided by the film thickness (mm) to afford the Elmendorf tear strength (N/mm). The results are shown in Table 5.

TABLE 2

| | | Refer- | Refer- | Refer- | Refer- | | | | | | |
|---|---|---|---|---|---|---|---|---|---|---|---|
| | | ence Ex- | ence Ex- | ence Ex- | ence Ex- | Exam- | Exam- | Exam- | Exam- | Exam- | Exam- |
| | | ample 1 | ample 2 | ample 3 | ample 4 | ple 18 | ple 19 | ple 20 | ple 21 | ple 22 | ple 23 |
| Blending | Thermoplastic resin | 100 | 50 | 30 | 70 | 54.9 | 65 | 70 | 70 | 67.5 | 68.5 |
| amount | (C-1) | | | | | | | | | | |
| (parts by | Thermoplastic resin | | 50 | 70 | | | | | | | |
| weight) | (C-2) | | | | | | | | | | |
| | Thermoplastic resin | | | | | | | | | | |
| | (C-3) | | | | | | | | | | |
| | Crosslinked resin | | | | 30 | | | | | | |
| | particles (A) | | | | | | | | | | |
| | Powdery/granular | | | | | 45.1 | | | | | |
| | material of Example 1 | | | | | | | | | | |
| | Powdery/granular | | | | | | 35 | 30 | | | |
| | material of Example 2 | | | | | | | | | | |
| | Powdery/granular | | | | | | | | 30 | | |
| | material of Example 3 | | | | | | | | | | |
| | Powdery/granular | | | | | | | | | 32.5 | |
| | material of Example 4 | | | | | | | | | | |
| | Powdery/granular | | | | | | | | | | 31.5 |
| | material of Example 5 | | | | | | | | | | |
| | Powdery/granular | | | | | | | | | | |
| | material of Example 6 | | | | | | | | | | |
| | Powdery/granular | | | | | | | | | | |
| | material of Example 7 | | | | | | | | | | |
| | Powdery/granular | | | | | | | | | | |
| | material of Example 8 | | | | | | | | | | |
| | Powdery/granular | | | | | | | | | | |
| | material of Example 9 | | | | | | | | | | |
| | Powdery/granular | | | | | | | | | | |
| | material of Example 10 | | | | | | | | | | |
| | Powdery/granular | | | | | | | | | | |
| | material of Example 11 | | | | | | | | | | |
| | Powdery/granular | | | | | | | | | | |
| | material of Example 12 | | | | | | | | | | |
| | Powdery/granular | | | | | | | | | | |
| | material of Example 13 | | | | | | | | | | |
| | Powdery/granular | | | | | | | | | | |
| | material of Example 14 | | | | | | | | | | |
| | Powdery/granular | | | | | | | | | | |
| | material of Example 15 | | | | | | | | | | |
| | Powdery/granular | | | | | | | | | | |
| | material of Example 16 | | | | | | | | | | |
| | Powdery/granular | | | | | | | | | | |
| | material of Example 17 | | | | | | | | | | |
| | Pentaerythritol | 1 | 1 | 1 | 1 | 1 | 1 | 1 | 1 | 1 | 1 |
| | Behenamide | 0.5 | 0.5 | 0.5 | 0.5 | 0.5 | 0.5 | 0.5 | 0.5 | 0.5 | 0.5 |
| Proportion | Thermoplastic resin | 100 | 50 | 30 | 70 | 54.9 | 65 | 70 | 70 | 67.5 | 68.5 |
| (wt %) | (C-1) | | | | | | | | | | |
| | Thermoplastic resin | | 50 | 70 | | | | | | | |
| | (C-2) | | | | | | | | | | |
| | Thermoplastic resin | | | | | | | | | | |
| | (C-3) | | | | | | | | | | |
| | Crosslinked resin | | | | 30 | 30 | 30 | 25.7 | 27.3 | 30 | 30 |
| | particles (A) | | | | | | | | | | |
| | Silica | | | | | 15.1 | 5 | 4.3 | 2.7 | 2.5 | 1.5 |
| | Talc | | | | | | | | | | |
| | Pentaerythritol | | | | | | | | | | |
| | α-Cyclodextrin | | | | | | | | | | |
| | Starch | | | | | | | | | | |
| Tensile | Yield stress (N/mm²) | 36 | — | — | 18 | 15 | 16 | 19 | 16 | 16 | 17 |
| characteristics | Elastic modulus (MPa) | 2765 | — | — | 1581 | 1530 | 1542 | 1659 | 1520 | 1509 | 1485 |
| | Stress at break (N/mm²) | 36 | — | — | 18 | 14 | 17 | 17 | 17 | 18 | 17 |
| | Tensile elongation at | 2 | — | — | 136 | 112 | 146 | 114 | 120 | 141 | 132 |
| | break (%) | | | | | | | | | | |

| | | | | | | | | | | |
|---|---|---|---|---|---|---|---|---|---|---|
| Tensile impact strength (kJ/m²) | 39 | 40 | 40 | 420 | 450 | 420 | 370 | 420 | 440 | 403 |

TABLE 3

| | | Exam- | Exam- | Exam- | Exam- | Exam- | Exam- | Exam- | Exam- | Exam- | Exam- |
|---|---|---|---|---|---|---|---|---|---|---|---|
| | | ple 24 | ple 25 | ple 26 | ple 27 | ple 28 | ple 29 | ple 30 | ple 31 | ple 32 | ple 33 |
| Blending | Thermoplastic resin | 89 | 67 | | | 44.5 | 33.5 | 26.7 | 20.1 | | 67 |
| amount | (C-1) | | | | | | | | | | |
| (parts by | Thermoplastic resin | | | 89 | 67 | 44.5 | 33.5 | 62.3 | 46.9 | | |
| weight) | (C-2) | | | | | | | | | | |
| | Thermoplastic resin | | | | | | | | | 89 | |
| | (C-3) | | | | | | | | | | |
| | Crosslinked resin | | | | | | | | | | |
| | particles (A) | | | | | | | | | | |
| | Powdery/granular | | | | | | | | | | |
| | material of Example 1 | | | | | | | | | | |
| | Powdery/granular | | | | | | | | | | |
| | material of Example 2 | | | | | | | | | | |
| | Powdery/granular | | | | | | | | | | |
| | material of Example 3 | | | | | | | | | | |
| | Powdery/granular | | | | | | | | | | |
| | material of Example 4 | | | | | | | | | | |
| | Powdery/granular | | | | | | | | | | |
| | material of Example 5 | | | | | | | | | | |
| | Powdery/granular | 11 | 33 | 11 | 33 | 11 | 33 | 11 | 33 | 11 | |
| | material of Example 6 | | | | | | | | | | |
| | Powdery/granular | | | | | | | | | | 33 |
| | material of Example 7 | | | | | | | | | | |
| | Powdery/granular | | | | | | | | | | |
| | material of Example 8 | | | | | | | | | | |
| | Powdery/granular | | | | | | | | | | |
| | material of Example 9 | | | | | | | | | | |
| | Powdery/granular | | | | | | | | | | |
| | material of Example 10 | | | | | | | | | | |
| | Powdery/granular | | | | | | | | | | |
| | material of Example 11 | | | | | | | | | | |
| | Powdery/granular | | | | | | | | | | |
| | material of Example 12 | | | | | | | | | | |
| | Powdery/granular | | | | | | | | | | |
| | material of Example 13 | | | | | | | | | | |
| | Powdery/granular | | | | | | | | | | |
| | material of Example 14 | | | | | | | | | | |
| | Powdery/granular | | | | | | | | | | |
| | material of Example 15 | | | | | | | | | | |
| | Powdery/granular | | | | | | | | | | |
| | material of Example 16 | | | | | | | | | | |
| | Powdery/granular | | | | | | | | | | |
| | material of Example 17 | | | | | | | | | | |
| | Pentaerythritol | 1 | 1 | 0 | 0 | 1 | 1 | 1 | 1 | 0 | 1 |
| | Behenamide | 0.5 | 0.5 | 0 | 0 | 0.5 | 0.5 | 0.5 | 0.5 | 0 | 0.5 |
| Proportion | Thermoplastic resin | 89 | 67 | | | 44.5 | 33.5 | 26.7 | 20.1 | | 67 |
| (wt %) | (C-1) | | | | | | | | | | |
| | Thermoplastic resin | | | 89 | 67 | 44.5 | 33.5 | 62.3 | 46.9 | | |
| | (C-2) | | | | | | | | | | |
| | Thermoplastic resin | | | | | | | | | 89 | |
| | (C-3) | | | | | | | | | | |
| | Crosslinked resin | 10 | 30 | 10 | 30 | 10 | 30 | 10 | 30 | 10 | 30 |
| | particles (A) | | | | | | | | | | |
| | Silica | 1 | 3 | 1 | 3 | 1 | 3 | 1 | 3 | 1 | 3 |
| | Talc | | | | | | | | | | |
| | Pentaerythritol | | | | | | | | | | |
| | α-Cyclodextrin | | | | | | | | | | |
| | Starch | | | | | | | | | | |
| Tensile | Yield stress (N/mm²) | — | 18 | — | — | — | — | — | — | — | 17 |
| characteristics | Elastic modulus (MPa) | — | 1567 | — | — | — | — | — | — | — | 1745 |
| | Stress at break (N/mm²) | — | 18 | — | — | — | — | — | — | — | 15 |
| | Tensile elongation at | — | 124 | — | — | — | — | — | — | — | 62 |
| | break (%) | | | | | | | | | | |

| | | | | | | | | | | |
|---|---|---|---|---|---|---|---|---|---|---|
| Tensile impact strength (kJ/m²) | 106 | 460 | 140 | 118 | 134 | 499 | 134 | 567 | 202 | 103 |

TABLE 4

| | | Exam- | Exam- | Exam- | Exam- | Exam- | Exam- | Exam- | Exam- | Exam- | Exam- |
|---|---|---|---|---|---|---|---|---|---|---|---|
| | | ple 34 | ple 35 | ple 36 | ple 37 | ple 38 | ple 39 | ple 40 | ple 41 | ple 42 | ple 43 |
| Blending | Thermoplastic resin | 68.5 | 67 | 67 | 54.9 | 89 | 69 | 70 | 67 | 68.5 | 67 |
| amount | (C-1) | | | | | | | | | | |
| (parts by | Thermoplastic resin | | | | | | | | | | |
| weight) | (C-2) | | | | | | | | | | |
| | Thermoplastic resin | | | | | | | | | | |
| | (C-3) | | | | | | | | | | |
| | Crosslinked resin | | | | | | | | | | |
| | particles (A) | | | | | | | | | | |
| | Powdery/granular | | | | | | | | | | |
| | material of Example 1 | | | | | | | | | | |
| | Powdery/granular | | | | | | | | | | |
| | material of Example 2 | | | | | | | | | | |
| | Powdery/granular | | | | | | | | | | |
| | material of Example 3 | | | | | | | | | | |
| | Powdery/granular | | | | | | | | | | |
| | material of Example 4 | | | | | | | | | | |
| | Powdery/granular | | | | | | | | | | |
| | material of Example 5 | | | | | | | | | | |
| | Powdery/granular | | | | | | | | | | |
| | material of Example 6 | | | | | | | | | | |
| | Powdery/granular | | | | | | | | | | |
| | material of Example 7 | | | | | | | | | | |
| | Powdery/granular | 31.5 | | | | | | | | | |
| | material of Example 8 | | | | | | | | | | |
| | Powdery/granular | | 33 | | | | | | | | |
| | material of Example 9 | | | | | | | | | | |
| | Powdery/granular | | | 33 | | | | | | | |
| | material of Example 10 | | | | | | | | | | |
| | Powdery/granular | | | | 45.1 | | | | | | |
| | material of Example 11 | | | | | | | | | | |
| | Powdery/granular | | | | | 11 | | | | | |
| | material of Example 12 | | | | | | | | | | |
| | Powdery/granular | | | | | | 31 | | | | |
| | material of Example 13 | | | | | | | | | | |
| | Powdery/granular | | | | | | | 30 | | | |
| | material of Example 14 | | | | | | | | | | |
| | Powdery/granular | | | | | | | | 33 | | |
| | material of Example 15 | | | | | | | | | | |
| | Powdery/granular | | | | | | | | | 31.5 | |
| | material of Example 16 | | | | | | | | | | |
| | Powdery/granular | | | | | | | | | | 33 |
| | material of Example 17 | | | | | | | | | | |
| | Pentaerythritol | 1 | 1 | 1 | 1 | 0 | 0 | 1 | 1 | 1 | 1 |
| | Behenamide | 0.5 | 0.5 | 0.5 | 0.5 | 0.5 | 0.5 | 0.5 | 0.5 | 0.5 | 0.5 |
| Proportion | Thermoplastic resin | 68.5 | 67 | 67 | 54.9 | 89 | 69 | 70 | 67 | 68.5 | 67 |
| (wt %) | (C-1) | | | | | | | | | | |
| | Thermoplastic resin | | | | | | | | | | |
| | (C-2) | | | | | | | | | | |
| | Thermoplastic resin | | | | | | | | | | |
| | (C-3) | | | | | | | | | | |
| | Crosslinked resin | 30 | 30 | 30 | 30 | 10 | 30 | 29.4 | 30 | 30 | 30 |
| | particles (A) | | | | | | | | | | |
| | Silica | 1.5 | 3 | 3 | | | | | | | |
| | Talc | | | | 15.1 | | | | | | |
| | Pentaerythritol | | | | | 1 | 1 | 0.6 | | | |
| | α-Cyclodextrin | | | | | | | | 3 | 1.5 | |
| | Starch | | | | | | | | | | 3 |
| Tensile | Yield stress (N/mm²) | 17 | 18 | 18 | 13 | 29 | 17 | 17 | 18 | 18 | 17 |
| characteristics | Elastic modulus (MPa) | 1455 | 1520 | 1465 | 1533 | 2426 | 1476 | 1500 | 1566 | 1541 | 1590 |
| | Stress at break (N/mm²) | 16 | 18 | 18 | 13 | 18 | 17 | 17 | 18 | 18 | 17 |
| | Tensile elongation at | 109 | 146 | 141 | 93 | 32 | 117 | 120 | 137 | 137 | 121 |
| | break (%) | | | | | | | | | | |

| | | | | | | | | | | |
|---|---|---|---|---|---|---|---|---|---|---|
| Tensile impact strength (kJ/m²) | 269 | 314 | 466 | 300 | 81 | 390 | 400 | 442 | 460 | 299 |

In Examples 18 to 25 and 33 to 43 in Tables 2 to 4, it is found that by blending the powdery and/or granular materials of Examples 1 to 17 including the crosslinked resin particles (A) and the aggregation inhibitor (B) into the thermoplastic resin (C), the impact strength of the thermoplastic resin (C) was improved as compared with Reference Example 1 in which none of the powdery and/or granular materials was blended.

Among them, Examples 18 to 23, 25, 36, and 39 to 42 exhibited a high level of impact strength, and in particular, Examples 18, 19, 21 to 23, 25, 36, and 40 to 42 exhibited impact strength equal to or higher than that of Reference Example 4 in which the aggregation inhibitor (B) was not contained and only the crosslinked resin particles (A) were blended.

### Examples 18 to 23, 25, and 33 to 43 Exhibited Tensile Properties Comparable to Those of Reference Example 4

In Examples 26 to 32 in Tables 2 to 4 as well, it is found that by blending the powdery and/or granular material of Example 6 including the crosslinked resin particles (A) and the aggregation inhibitor (B) into the thermoplastic resin (C), the impact strength of the thermoplastic resin (C) was improved as compared with Reference Example 2 or 3 in which the powdery and/or granular material was not blended.

TABLE 5

| | | Reference | Reference | Exam- | Exam- | Exam- | Exam- | Exam- | Exam- | Exam- | Exam- |
|---|---|---|---|---|---|---|---|---|---|---|---|
| | | Example 1 | Example 5 | ple 44 | ple 45 | ple 46 | ple 47 | ple 48 | ple 49 | ple 50 | ple 51 |
| Blending | Thermoplastic resin | 100 | 50 | 41.7 | 45 | 47.5 | 45 | 47.5 | 45 | 49 | 45 |
| amount | (C-1) | | | | | | | | | | |
| (parts by | Crosslinked resin | | 50 | | | | | | | | |
| weight) | particles (A) | | | | | | | | | | |
| | Powdery/granular | | | 58.3 | | | | | | | |
| | material of Example 2 | | | | | | | | | | |
| | Powdery/granular | | | | 55 | | | | | | |
| | material of Example 3 | | | | | | | | | | |
| | Powdery/granular | | | | | 52.5 | | | | | |
| | material of Example 5 | | | | | | | | | | |
| | Powdery/granular | | | | | | 55 | | | | |
| | material of Example 7 | | | | | | | | | | |
| | Powdery/granular | | | | | | | 52.5 | | | |
| | material of Example 8 | | | | | | | | | | |
| | Powdery/granular | | | | | | | | 55 | | |
| | material of Example 10 | | | | | | | | | | |
| | Powdery/granular | | | | | | | | | 51 | |
| | material of Example 14 | | | | | | | | | | |
| | Powdery/granular | | | | | | | | | | 55 |
| | material of Example 17 | | | | | | | | | | |
| | Pentaerythritol | 1 | 1 | 1 | 1 | 1 | 1 | 1 | 1 | 0 | 1 |
| | Behenamide | 0.5 | 0.5 | 0.5 | 0.5 | 0.5 | 0.5 | 0.5 | 0.5 | 0.5 | 0.5 |
| Proportion | Thermoplastic resin | 100 | 50 | 41.7 | 45 | 47.5 | 45 | 47.5 | 45 | 49 | 45 |
| (wt %) | (C-1) | | | | | | | | | | |
| | Crosslinked resin | | 50 | 50 | 55 | 50 | 50 | 50 | 50 | 50 | 50 |
| | particles (A) | | | | | | | | | | |
| | Silica | | | 8.3 | 5 | 2.5 | 5 | 2.5 | 5 | | |
| | Pentaerythritol | | | | | | | | | 1 | |
| | Starch | | | | | | | | | | 5 |

| | | | | | | | | | | |
|---|---|---|---|---|---|---|---|---|---|---|
| Elmendorf tear strength (N/mm) | 4 | 94 | 116 | 125 | 124 | 139 | 126 | 124 | 100 | 130 |

In Examples 44 to 51 in Table 5, it is found that the values of Elmendorf tear strength were increased by blending the powdery and/or granular material of each Example including the crosslinked resin particles (A) and the aggregation inhibitor (B) into the thermoplastic resin (C), as compared with Reference Example 1 in which only the thermoplastic resin (C) was blended or Reference Example 5 in which only the crosslinked resin particles (A) were blended into the thermoplastic resin (C).

1. A powdery and/or granular material having a median diameter of from 20 μm to 10 mm, wherein
the powdery and/or granular material comprises crosslinked resin particles (A) and an aggregation inhibitor (B), and
the crosslinked resin particles (A) comprise a polyhydroxyalkanoate resin, and have a gel fraction of at least 50% and a volume mean diameter of from 0.1 μm to 10 μm.

2. The powdery and/or granular material according to claim 1, wherein a proportion of the crosslinked resin particles (A) in a total amount of the crosslinked resin particles (A) and the aggregation inhibitor (B) is from 10 to 99.5 wt %.

3. The powdery and/or granular material according to claim 1, wherein the polyhydroxyalkanoate resin is a poly(3-hydroxyalkanoate) resin.

4. The powdery and/or granular material according to claim 1, wherein the crosslinked resin particles (A) are resin particles crosslinked using a peroxide.

5. The powdery and/or granular material according to claim 4, wherein the crosslinked resin particles (A) are resin particles crosslinked in the presence of a polyfunctional compound additionally.

6. The powdery and/or granular material according to claim 1, wherein a proportion of the polyhydroxyalkanoate resin in the crosslinked resin particles (A) is at least 80 wt %.

7. The powdery and/or granular material according to claim 1, wherein a surface coverage of the crosslinked resin particles (A) with the aggregation inhibitor (B) is from 10 to 100%.

8. The powdery and/or granular material according to claim 1, wherein the aggregation inhibitor (B) is an inorganic component.

9. The powdery and/or granular material according to claim 1, wherein the aggregation inhibitor (B) is a polyhydric alcohol.

10. The powdery and/or granular material according to claim 1, wherein the aggregation inhibitor (B) is a polysaccharide.

11. The powdery and/or granular material according to claim 1, wherein the aggregation inhibitor (B) is an oligosaccharide.

12. A method for producing the powdery and/or granular material of claim 1, the method comprising:
preparing an aqueous dispersion comprising crosslinked resin particles (A) and an aggregation inhibitor (B); and
spray drying the aqueous dispersion.

13. A thermoplastic resin composition comprising the powdery and/or granular material of claim 1, and a thermoplastic resin (C).

14. The thermoplastic resin composition according to claim 13, wherein the thermoplastic resin (C) comprises a biodegradable resin.

15. A molded article produced by molding the thermoplastic resin composition of claim 13.

16. The powdery and/or granular material according to claim 1, wherein the gel fraction of at least 70%.

17. The powdery and/or granular material according to claim 1, wherein the volume mean diameter is from 0.5 μm to 8 μm.

18. The powdery and/or granular material according to claim 1, wherein the median diameter of the powdery and/or granular material is from 35 μm to 3 mm.

19. The powdery and/or granular material according to claim 1, wherein the median diameter of the powdery and/or granular material is from 20 μm to 500 μm.

20. The powdery and/or granular material according to claim 1, wherein the surface coverage of the crosslinked resin particles (A) with the aggregation inhibitor (B) is from 50 to 100%.
